(19) United States
(12) Patent Application Publication
(10) Pub. No.: US 2003/0115262 A1
(43) Pub. Date: Jun. 19, 2003

(54) System and method for sending messages through the network by a mobile messaging agent

(76) Inventor: Chien-Hung Dai, Shan-Chung (TW)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/179,563

(22) Filed: Jun. 17, 2002

(30) Foreign Application Priority Data
Dec. 19, 2001 (TW) 090131583

(51) Int. Cl. G06F 15/16

(52) U.S. Cl. 709/203

(57) ABSTRACT

A system and a method for sending a message over the communication network, such as the Internet, by the mobile messaging agent are disclosed. Mails can be actively sent and received following the location of the computer where the user is located. The messaging mechanism comprises: a Messenger, serving as a messenger program dedicated to the user, including a mailbox of the user, which facilitates the user to send/receive and manage the messages and mails, wherein the program itself has mobility so that when the user turns on the computer and pages the Messenger, the Messenger can travel in a real time manner to the user's computer; a Messenger Finder, which is a program installed on the user's computer, for locating the user's Messenger; an Agent Finder, which is a program installed on the computer at the network server, for recording the current location of each Messenger program, and looking up the location of the Messenger. Mails to be sent may be rolled back when the recipient is not on-lined to receive mails. The mobile mailbox mechanism of the present invention can render the Messenger automatically traveling to the computer where the user is located so that the user can asynchronously manage the associated mailbox. The present invention needs not a serving host to transmit messages and mails.

### BACKGROUND OF THE INVENTION

1. Field of the Invention

The present invention relates to a system and method for sending messages over the network, such as the network, and more specifically, to a system and method for actively receiving and sending messages by activating a Messenger program.

2. Background of the Invention

With high development of advanced technologies, communication network, such as the network, has been well developed. At the beginning of 1998, the population of the users on the network across the world was about 100 million. With the rapid spreading of the network, more and more people utilize the network to send messages. According to the Information Industry Institute of Taiwan, by the end of 1999, there were 4.8 million network users in Taiwan, and over 72.1% of them used the Internet mainly to receive/send e-mails (FIND center, III, Taiwan, 2000). In the United States, there were over 100 million network users in 2000, and almost 20 million e-mails were transmitted over the Internet. Furthermore, according to the investigation data made by NetValue in April 2000, five Asian countries, including Taiwan, Hong Kong, Singapore, Korea and China, have almost the same number of the population that use the Internet, and almost all users may browse web sites. Up to 69.1% of the Internet users in Taiwan use e-mail as a transmission medium to send personal messages.

Sending messages over the communication network, such as the Internet, mainly involves using e-mail and ICQ personal paging. These two means of sending message involve first sending a request to the server receive and send messages from the client to the server over the Internet. Then, the server acknowledges the request. Finally, the client downloads messages or mails from the server.

The mobile agent according to the present invention relates to a distributed architecture technology of a software system, in which the major components comprise the place and the agent. The place generally refers to a computer (PC) itself, in which activities of the agent takes place. The agent refers to a software object program running on the place (i.e. the computer). The agent is characterized by mobility, communication and behavior. Mobility means that the agent travels from one place to another, such as from computer A to computer B. Communication means the communicating functions between two different agents. A user can also communicate with the agent via the software program. The communicating functions are usually used to command or control the agent to conduct the behaviors requested by the user. Behavior means the agent's activities, such as receiving/sending messages, calculating Figures, extracting spreadsheet data, etc., which usually refer to the procedures to be executed in the agent program.

### BRIEF DESCRIPTION OF THE INVENTION

The present invention develops a Messenger based on the features and principles of the “mobile agent” technology. The Messenger plays the role of an assistant to the user, which is responsible for assisting the user in receiving and sending messages, such as mails, account security alarms, stock market information and goods sales information, etc. The Messenger can be a software program, which randomly travels over the network. Due to the changing of the location of the Messenger, a Messenger locating agent mechanism, called Agent Finder is required for the convenience of the user. The Messenger has first to register itself with the Agent Finder. When the user desires to page his dedicated Messenger, he can look it up through the mechanism of the Agent Finder. According to the present invention, the registration mechanism is established based on the architecture of the mobile agent. Further, the user at the client end may page the Messenger via an interface management tool for the Messenger Finder. According to the present invention, the interface is also established based on the architecture of the mobile agent.

One advantage of the present invention is that the Messenger may assist the user in receiving and sending messages and mails over the network, such as the Internet. The Messenger has the ability of mobility and can automatically locate the user, and the Messenger has the ability to advantageously set up the messaging scheme over the network, thus achieving advantageous effects of active message forwarding and message mobility. No matter where the user is, the Messenger can actively locate that user.

Another advantage of the present invention is to reduce the word load of the server on the network and the network bandwidth. Because the user has his dedicated Messenger program to receive/send messages and mails, the messages and mail information of the user will not be repetitively sent over the network, and thus the server can handle much less messages and mails, and the user's registration process. Further, it is convenient because the user only needs a single entry to access his messages.

Another advantage of the present invention is the rolling back mechanism for the sending out mail. Because the e-mail is stored in the Messenger according to the present invention, before the recipient is ready to get on-lined to receive his mails, his mails are not sent out but temporarily stored in the Messenger associated with the sender (i.e. stored in the mailbox of the Messenger). In this case, the sender may regret sending the mail anytime and roll back the mail by deleting the mail in the mailbox of the Messenger.

### BRIEF DESCRIPTION OF THE DRAWINGS

The present invention will be described and illustrated in connection with the following drawings, in which:

FIG. 1 illustrates a schematic diagram of the mobile Messenger according to the present invention;

FIG. 2 illustrates a system state diagram of the mobile Messenger according to the present invention;

FIG. 3 illustrates a system operating diagram of the mobile Messenger according to the present invention;

FIG. 4 illustrates an operational flow chart of the mobile Messenger according to the present invention;

FIG. 5(a) shows a display in a Windows Command mode when the Agent Finder is activated;

FIG. 5(b) shows a control window of the mobile agent platform when the Agent Finder is activated;

FIG. 5(c) shows a display when the user registers with the download web site of the mobile Messenger;

FIG. 5(d) shows a display in a Windows Command mode when the Messenger Finder is activated;

FIG. 5(e) shows a Java™ Swing display for the Messenger Finder;

FIG. 5(f) shows a display in a Windows Command mode when the Messenger Finder is activated;

FIG. 5(g) shows a control window for the mobile agent platform when the register is activated;

FIG. 5(h) shows a display in a Windows Command mode when the register is about to travel;

FIG. 5(i) shows a display in a Windows Command mode when the register arrives at the server;

FIG. 5(j) shows a control window for the mobile agent platform when the register arrives at the server;

FIG. 5(k) illustrates a display where account and password are entered for registration;

FIG. 5(l) shows a control window for the mobile agent platform when the Agent Finder creates a Messenger;

FIG. 5(m) shows a display in a Windows Command mode when the Messenger is created;

FIG. 5(n) shows a display in a Windows Command mode when the Messenger is paged;

FIG. 5(o) shows a display in a Windows Command mode when the Messenger is about to travel;

FIG. 5(p) shows a control window for the mobile agent platform when the Messenger arrives at the client;

FIG. 5(q) shows a display in a Windows Command mode when the Messenger arrives at the client;

FIG. 5(r) shows a display when the user has successfully registered with the mobile agent system according to the present invention;

FIG. 5(s) shows a display for sending a mail;

FIG. 5(t) shows a display for opening a mail;

FIG. 5(u) shows a display for the function of a friend's list;

FIG. 5(v) shows a dialog box for the chat room;

FIG. 5(w) shows a display when a user logs off the Messenger Finder;

FIG. 5(x) shows a display in a Windows Command mode when the Messenger is about to return to the server;

FIG. 5(y) shows a Tahiti window when the Messenger returns to the server;

FIG. 5(z) shows a display in a Windows Command mode when the Messenger returns to the server;

FIG. 6(a) illustrates a diagram for the combination of the mobile Messenger system and the Thin-client equipment;

FIG. 6(b) illustrates a basic structure of the AT-command line;

FIG. 6(c) illustrates a diagram of the WAP gateway connecting to the computer network and the telecommunication network;

FIG. 6(d) illustrates a diagram of Java Servlet on the Nokia WAP server; and

FIG. 6(e) illustrates the development interface of Nokia Toolkit.

### DETAILED DESCRIPTION

The embodiments according to the present invention will be illustrated with reference to the accompanying drawings, in which like elements have like reference numerals throughout the drawings. In the present invention, a Messenger is developed based on the features and principles of the mobile agent. The Messenger plays the role of an assistant to user 1, which is responsible for receiving and sending messages of user 1, such as mails, account security alarms, stock market information, and goods sales information, etc. The Messenger freely travels over the network. Messengers on the network may transmit and exchange messages with each other. Because of the changing of the location of the Messenger, a Messenger locating agent mechanism, called the Agent Finder is required. Each Messenger first has to register with the Agent Finder mechanism. When the user 1 desires to page his dedicated Messenger, he can look for it through the Agent Finder. The registration mechanism is established based on the technology of the mobile agent. Further, the user 1 at the client may page the Messenger via an interface management tool program of the Messenger Finder. The interface is also established based on the architecture of the mobile agent.

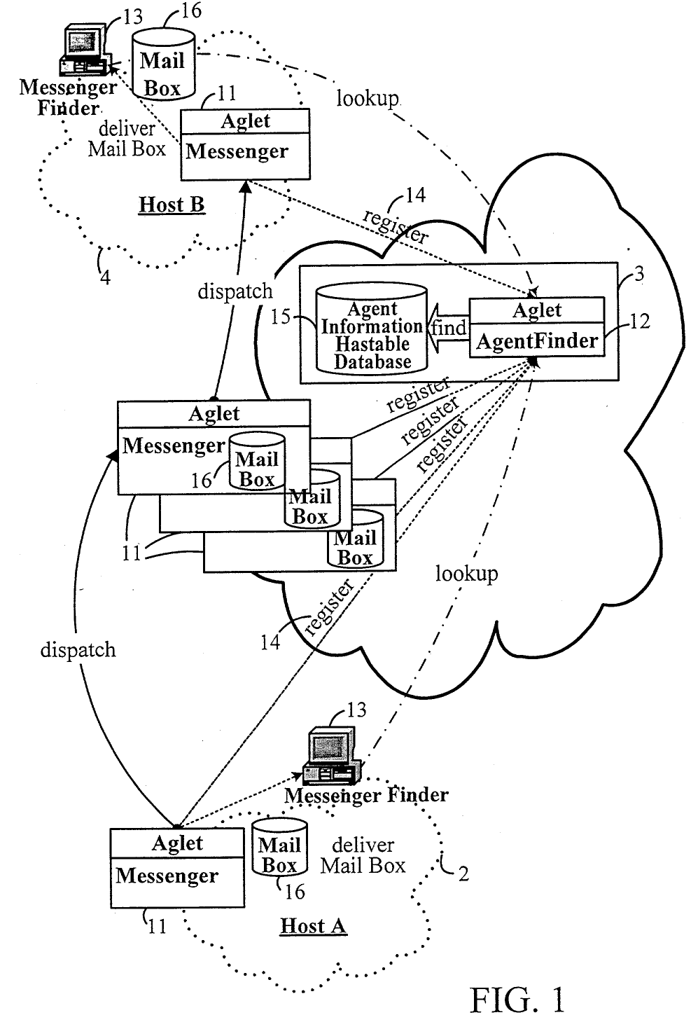

As shown in FIG. 1, mobile messaging agent system 10 according to the present invention is established on the communication network, such as the Internet. A Messenger Finder 13 used by the clients 2 and 4 is an interface management program between the user 1 and the mobile messaging agent system 10. The program 13 may dispatch the Messenger 11 onto the network to receive/send messages. Once the Messenger Finder 13 is activated, even if the user 1 travels from one location (for example, from the host A of the client 2 to another (for example, to the host B of the client 4), the Messenger 11 can automatically locate the user 1, and forward the messages associated with the user 1, such as a mailbox 16, to the host B at the client 4 of the user 1. The mailbox 16 for the Messenger 11 is permanent and unique.

The mechanism for performing the receiving/sending mails by the mobile Messenger according to the present invention is described below.

Sending Mails (or Messages):

When sending mails or messages, the mails or messages of the user to be sent will be placed in the sending box of the mailbox 16 in the Messenger 11. The Messenger 11 first informs the Agent Finder 12 through the Proxy for the Agent Finder 12 that mails or messages are to be sent to the Messenger 11 of the user. Then, the Agent Finder 12 looks up Agent Information Database 15 to see if the user is on-lined or not, and returns, through the Proxy for the Messenger 11, the on-line status of the user as well as the Proxy for the Messenger for the recipient to the Messenger 11. If the user at the sending end is on-lined, his/her Messenger 11 will send the mails or messages to the Messenger 11 of the recipient through the Proxy for the Messenger 11 of the recipient. If the user at the receiving end is not on-lined, the Messenger 11 of the user at the sending end will not send mails or messages to the Messenger 11 of the recipient. Instead, the Agent Finder 12 then records in the Agent Information Database 15, the information that the user at the receiving end has mails. Then, when the user at the receiving end is on-lined, he will receive a notification from the Agent Finder 12, and the Messenger 11 of the sender will send mails or messages to the Messenger 11 of the recipient through the Proxy for the Messenger 11 of the recipient.

Receiving Mails (or Messages):

When on-lined, the user will activate the Messenger Finder 13, and page the Messenger 11. Then, the Messenger 11 sends out the user on-line signal to the Agent Finder 12. Next, the Agent Finder 12 will look up in the Agent Information Database 15 to see if there are mails for the user. If affirmative, the Agent Finder 12 then sends out the user on-line message, and the Proxy for the Messenger 11, before being notified, has the record for sending mails or messages to the Messengers 11 for the users. Thus, these Messengers 12 having mails therein send the mails or messages to be sent to the Messenger 11 through the Proxy for the Messenger 11. When the Messenger 11 receives the mails or messages, it will store these mails or messages in the receiving box of the mailbox 16. When the Messenger 11 comes to the client computer, the Messenger 11 will send these mails and messages to the Messenger Finder 13.

Rolling back Mails Sent:

When the user performs the rolling back function for the mails sent with the Messenger Finder 13, the Messenger 11 will send the rolling back mail message to notify the Agent Finder 12 through the Proxy for the Agent Finder 12, and the Agent Finder 12 will modify the data in the Agent Information Database 15 and delete the recipient data that mails or messages are to be sent to the user. Then, if the mails or messages are not sent out and stored in the sending box of the mailbox 16, the Messenger 11 will pick up the mails or messages and return to the user for modification or deletion.

The mobile messaging agent system 10 according to the present invention mainly comprises the following elements:

Messenger 11:

The Messenger is an agent program created by the Agent Finder 12 when the user 1 registers onto the Agent Finder 12, so that the Messenger 11 will be registered as a dedicated Messenger for the user 1, in which the information of the user will be used for identifying the user 1 to which the Messenger 11 belongs. The Messenger normally is a mail and Messenger traveling over the network, which is responsible for receiving mails and messages for the user 1. It is designed with IBM Aglet™ and implemented by establishing dispatch and registering (Register 14) mechanism. It is configured with a mailbox and a friend's list for the user 1. The mailbox herein is a place for storing the mails, and the friend's list is used for storing the information of good friends configured by the user 1. When the user 1 at the client 2 is activated, the Messenger 11 can travel to the location of the user 1. The Messenger 11 can function to page, look for, receive mails, cancel mails to be sent (when the recipient is not on-lined to receive mails), and configure the friend's list as well as the chatting room.

Agent Finder 12:

Agent Finder 12, configured in the host at the server, monitors the changing of the locations and statuses of all the Messengers 11 on the network, and also manages the commands sent by the user 1 to the dedicated Messenger 11. Agent Finder 12 has the following main functions:

Generating Messenger 11: when the user 1 registers with the mobile Messenger system for the first time, it will apply for an account from the system 10, and registers a Messenger 11. After completion of registration, the user 1 may send out a message for generating new Messenger to the Agent Finder 12 through the Messenger Finder 13. When the Agent Finder 12 receives such a message, it will create a messenger object program based on the class interface of the Messenger 11. This program is a messenger of the user 1.

Monitoring Messenger 11: when the Messenger 11 arrives at the destination place, it sends to the Agent Finder 12 the Register 14, which describes the current location of the Messenger 11. The Agent Finder 12 will store the information (the current location of the Messenger 11) in the Agent Information Database 15 so as to facilitate tracking of the location of the Messenger 11.

Responding to a look-up signal from the user 1 for Messenger 11: When the user 1 of the Messenger 11 activates the Messenger Finder 13, the Messenger Finder 13 will automatically send out a lookup message to the Agent Finder 12 and request locating the Messenger 11 of the user 1. The Agent Finder 12 then locates the Messenger 11 according to the information stored in the Agent Information Database 15, and notifies the Messenger 11 of the request command of the user 1.

Messenger Finder 13:

Messenger Finder 13 is a program installed on the host of the clients 2 and 4, and has to be downloaded into the computer, when the user 1 registered with the mobile messaging agent system 10 for the first time, serving as an interface program by which the user 1 can communicate with the mobile Messenger 11. When activated, the Messenger Finder 13 then looks for the Agent Finder 12 on the network through another Register 14 located on the clients 2 and 4. Then, the Messenger Finder 13 will send out the “Lookup” message to the Agent Finder 12, requesting locating the Messenger 11 associated with the user 1. The Agent Finder 12 will accordingly send back the Proxy for the Messenger 11 to the Messenger Finder 13, and then the Messenger Finder 13 may page the Messenger 11 through the Proxy. Because the Messenger Finder 13 is configured to exchange messages with the Messenger 11 and the Agent Finder 12, the Messenger Finder 13 is an interface program developed with the mobile agent structure. The interface program has functions of chatting room, receiving/sending mails, canceling sending mails (when the recipient is not on-lined to receive mails), and managing the friend's list.

Register 14:

Register 14 is an agent program installed on the clients 2 and 4, and is one of the elements to be downloaded into the computer when the user 1 logs in the system 10 for the first time. When activated, the Messenger Finder 13 will generate the Register 14 so as to locate the Agent Finder 12 on the network. Once the Agent Finder 12 is located, the Register 14 returns the Proxy for the Agent Finder 12 to the Messenger Finder 13. This Proxy serves as a bridge between the Messenger Finder 13 and the Agent Finder 12.

Agent Information Database 15:

Agent Information Database 15 is a database for storing the information of the Messenger 11, which records the Proxy at the changing of the location of each of Messengers 11 traveling over the network. This Proxy can serves as a bridge between the Messenger Finder 13 and the Messenger 11. Generally, the Agent Finder 12 is requested by the user 1 through the client agent program 13 to provide with the Proxy for the belonged Messenger 11. The Agent Finder 12 then gets the Proxy for the Messenger 11 associated with the user 1 from the database and sends it to the user 1. Only the agent program (i.e. the Agent Finder 12) responsible for managing the Messenger 11 is permitted to access to database 15.

Mailbox 16:

Mailbox 16 is a database for storing the mails. Each Messenger 11, embedded with a mailbox, can be considered as a traveling mailbox, characterized in that the traveling mailbox can unlimitedly travel over the network at any time. If desired, the traveling mailbox can be paged to receive/send mails or messages, and thereby it is more convenient, synchronous and simple for the mail management. This can avoid the drawbacks encountered in using conventional e-mails that a user has to be configured with different accounts for accessing to e-mails at multiple locations, which is not convenient for mail management.

Proxy for the Agent:

Proxy is the main window by which the user in the external environment can control the mobile agent, and is also the message manager of the mobile agent. The Proxy is used for the purposes of: (1) managing the utilities for accessing to the agent, which transmit the status, contents and attributes of the agent program from computer A to computer B by means of the Mobile Code Technology; and (2) facilitating to control the local and remote agent programs. The mobile agent in the system according to the present invention is dispatched by the Proxy to instruct the physical movement of the mobile agent. No matter whether the agent program is remote from or near the user, the user can control the mobile agent by mastering the Proxy, for example, the Agent Finder 12 in the present invention. The Proxy for the Messenger 11 is recorded in the Agent Information Database 15. Thus, when the user has a request for his dedicated Messenger 11, the Agent Finder 12 will send the Proxy for the Messenger 11 to the Messenger Finder 13. Once the Messenger Finder 13 has the Proxy for the Messenger 11, it may exert complete control over the Messenger 11. However, the Proxy is created by the AgletContext platform platform. While paging the mobile agent to dispatch through the Proxy, the Proxy may lose its control over the agent program because the mobile agent has traveled to another AgletContext platform platform. The mobile agent will create a new Proxy from another AgletContext platform. Thus, whenever the Proxy executes the dispatch ( ) function, the dispatch ( ) function will generate a new Proxy to control the remote mobile agent.

When the user 1 logs in the mobile messaging agent system 10 for the first time, he has to first register with the Agent Finder 12, which will create a dedicated Messenger 11 (to be described below). The Messenger 111 then becomes the Messenger for the user 1. According to one embodiment of the present invention, the Messenger 11 is embedded with a mailbox 16. The Messenger 11 will register the location of the Messenger 111, for example, the Proxy used for the new location of the Messenger 11, in the Agent Finder 12 during its generation. Therefore, no matter where the Messenger 11 is, the Agent Finder 12 can track the Messenger 11, which is described below in detail.

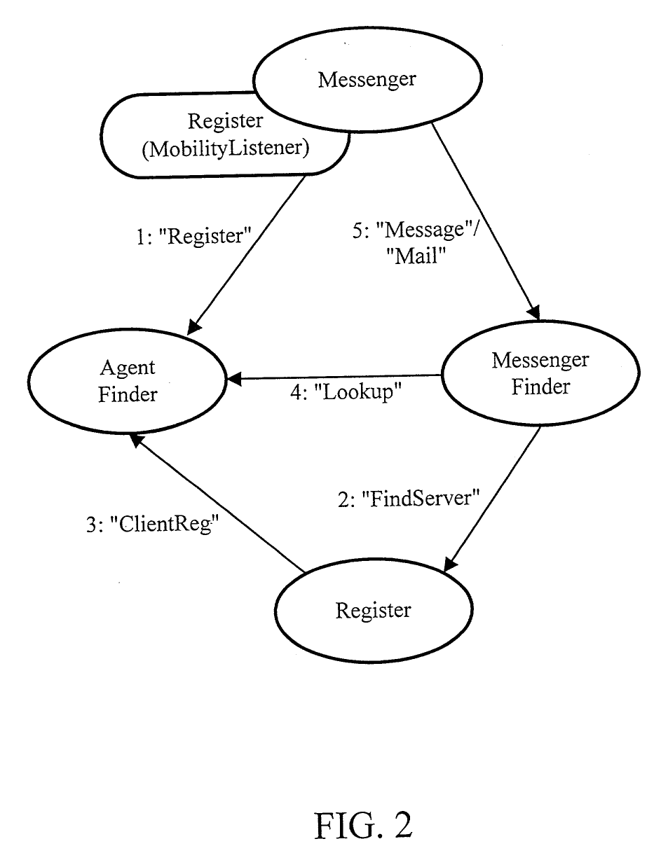

FIG. 2 illustrates a state diagram 20 of the mobile messaging agent system 10 according to the present invention, which describes the interactive relations among the Messenger Finder 13, the Register 14, the Agent Finder 12, and the Messenger 11. The Messenger 11 is created when the user 1 is initially registered with the Agent Finder 12, and usually dynamically travels over the network. The Messenger Finder 13 is the interface program for the user 1, and the Register 14 is installed in the computers at clients 2 and 4. The Agent Finder 12 located on the server is intended to locate the Messenger 11. The solid arrow in the state diagram 20 represents the information flow. The following steps are the operational flow from the view point of the mobile messaging agent system 10:

(1) The Messenger 11 pages the Register 14 to register with the Agent Finder 2.

(2) The Messenger Finder 13 sends out a message, such as “Findserver,” paging the Register 14 to locate the Agent Finder 12 over the network.

(3) The Register 14 locates the Agent Finder 12, and sends out a message, such as “ClientReg,” to the Agent Finder 12, indicating that the clients 2 and 4 want to use the control messages or means of the Agent Finder 12, such as the Proxy. The Register 14 then sends the control messages or means, such as the Proxy, available by the Agent Finder 12 to the Messenger Finder 13.

(4) The Messenger Finder 13 sends to the Agent Finder 12 via the Proxy for the Agent Finder 12 a message, such as “Lookup,” indicative of locating the Messenger 11. In response, the Agent Finder 12 then looks up in the Agent Information Database 15 and locates the Proxy at the current location of the Messenger 11 when traveling over the network, and sends the control messages or means of the Messenger 11, such as the Proxy, to the Messenger Finder 13. The Messenger Finder 13 can locate the Messenger 11 based on the Proxy.

(5) The Messenger Finder 13 requests, through the control messages or means of the Messenger 11, such as the Proxy, that the Messenger 11 travel to the client 4. The located Messenger 11 then arrives at the client 4, and sends the messages associated with the user to the Messenger Finder 13.

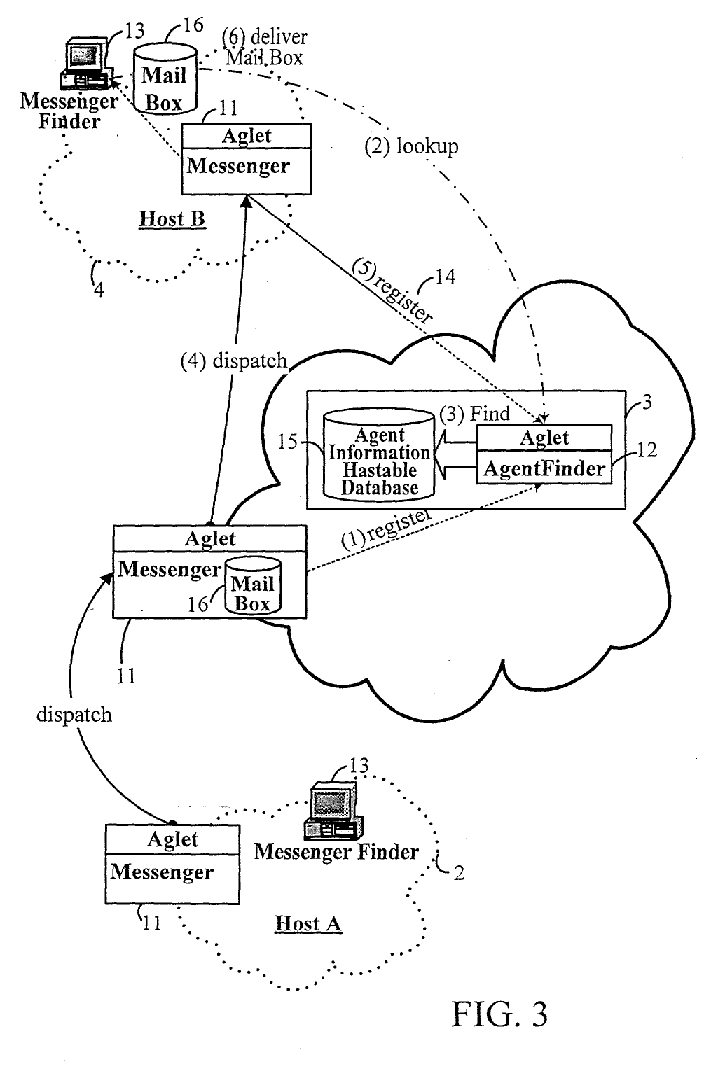

FIG. 3 illustrates an operational diagram for the mobile messaging agent system 10 according to the present invention from the viewpoint of the user 1 with reference to the state diagram of FIG. 2. Take the case that the user 1 migrates from the client 2 to the client 4 for example. (1) When the Messenger 11 initially travels from the client 2 to the client 4 over the network, it will send the Register 14 to the Agent Finder 12, requesting to register with the client 4, i.e., the computer at which the Messenger Finder 13 is located. (2) After the user 1 logs in the mobile messaging agent system 10 at the client 4, the Messenger Finder 13 sends the message “Lookup” to the Agent Finder 12, requesting locating the Messenger 11. (3) The Agent Finder 12 looks up the Messenger 11 in the agent database 15. (4) The Messenger 11 is dispatched to the client 4 where the user 1 is located. (5) After the Messenger 11 has arrived at the client 4, it then sends the Register 14 to the Agent Finder 12, registering the new location with the Agent Finder 12. (6) The Messenger 11 downloads the data and the friend's list stored in the mailbox 16 to the Messenger Finder 13.

Operating Example of the System

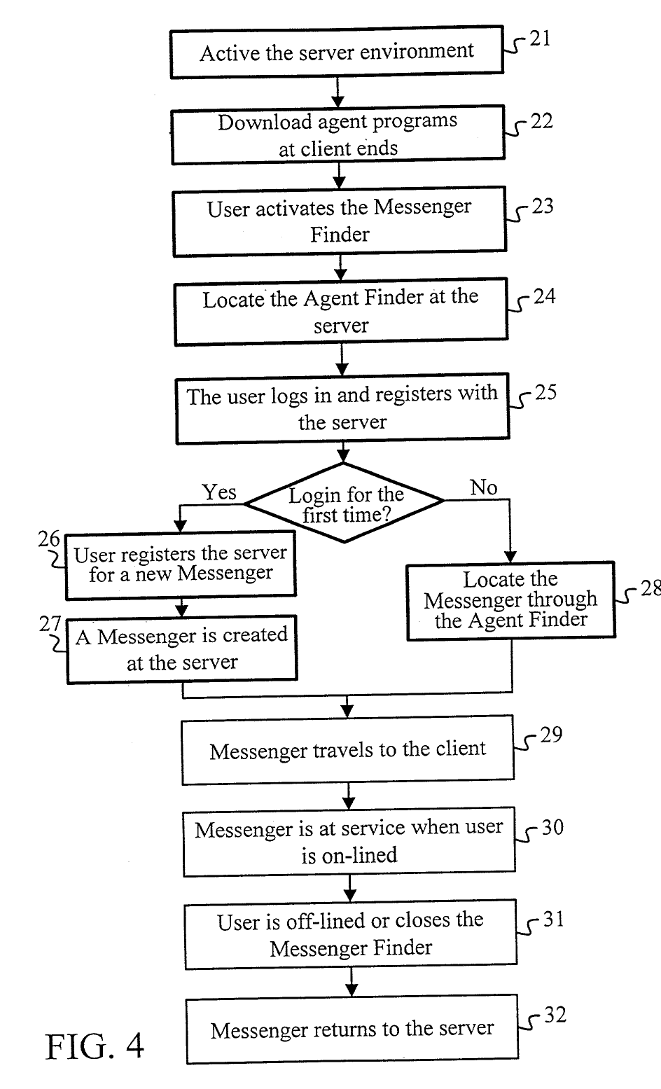

As shown in the flowchart of FIG. 4, according to a preferred embodiment of the present invention, the operation example of the mobile messaging agent system 10 is given as follows:

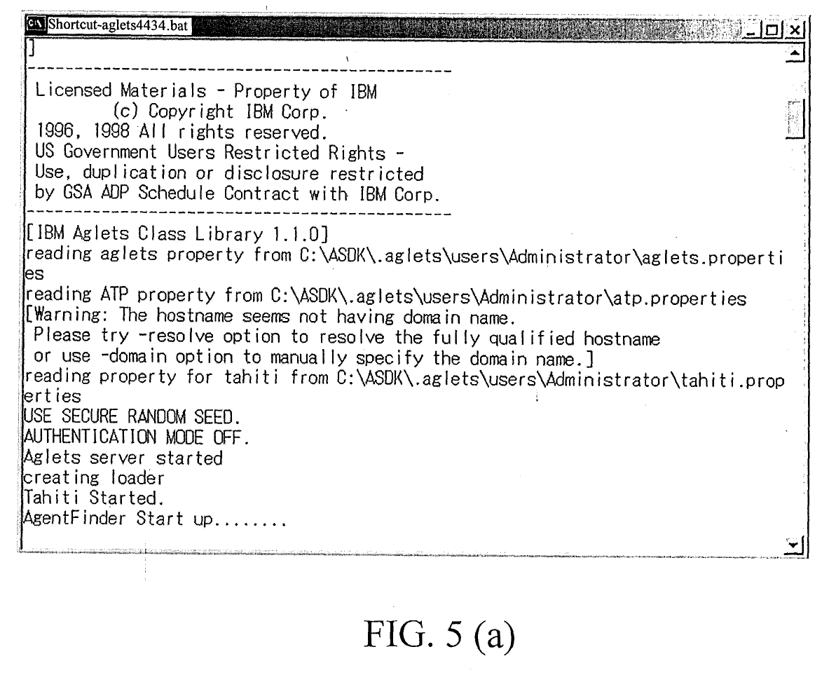

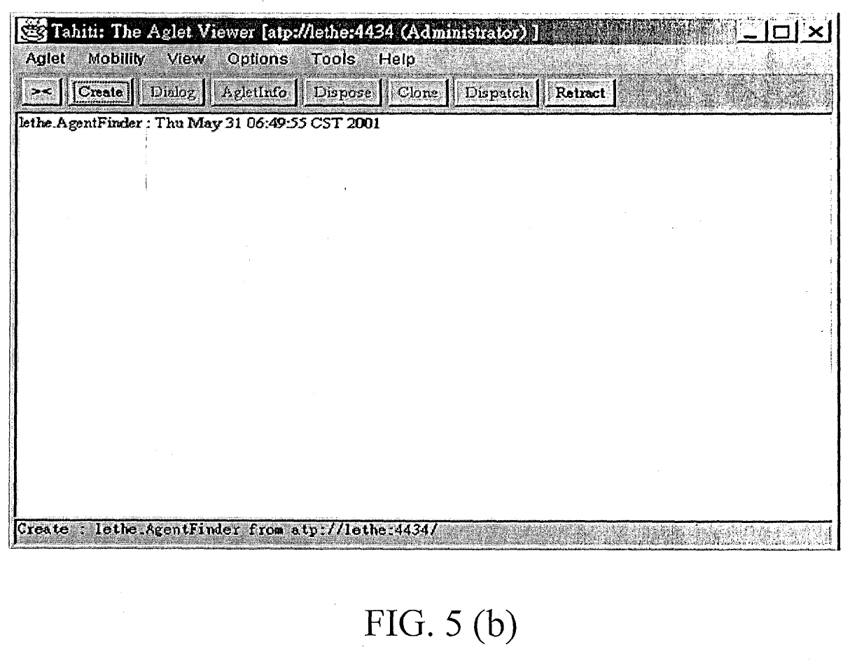

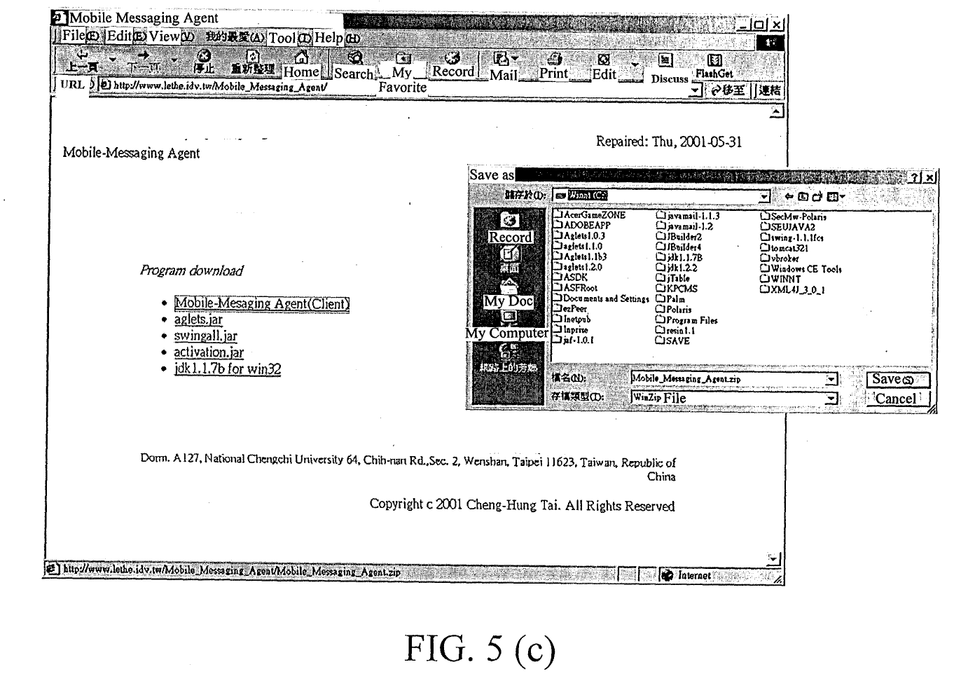

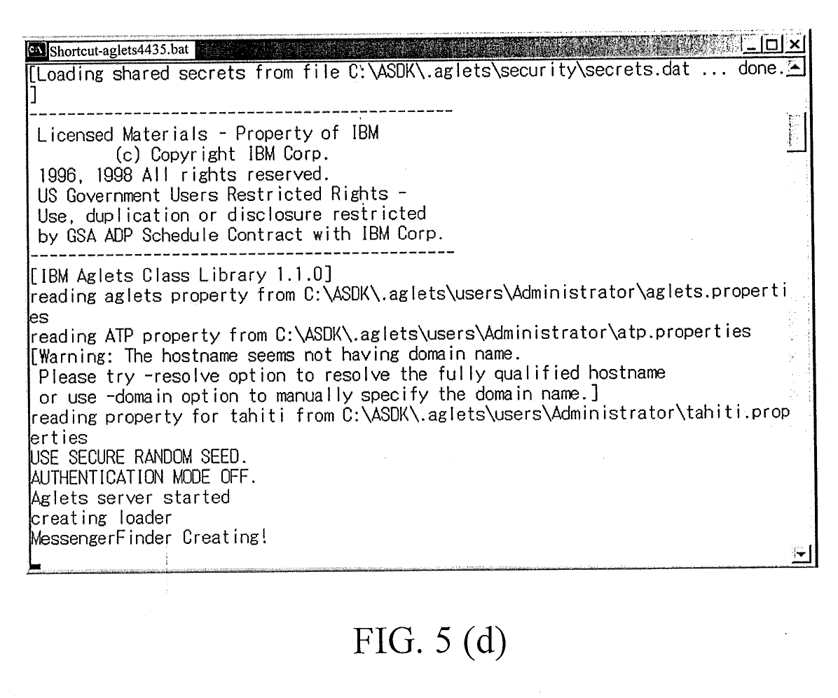

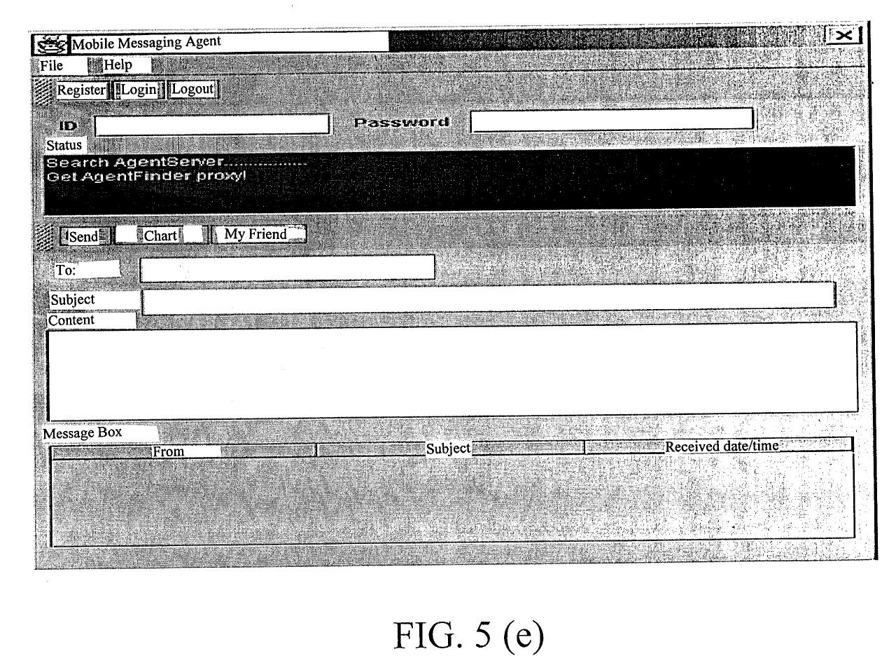

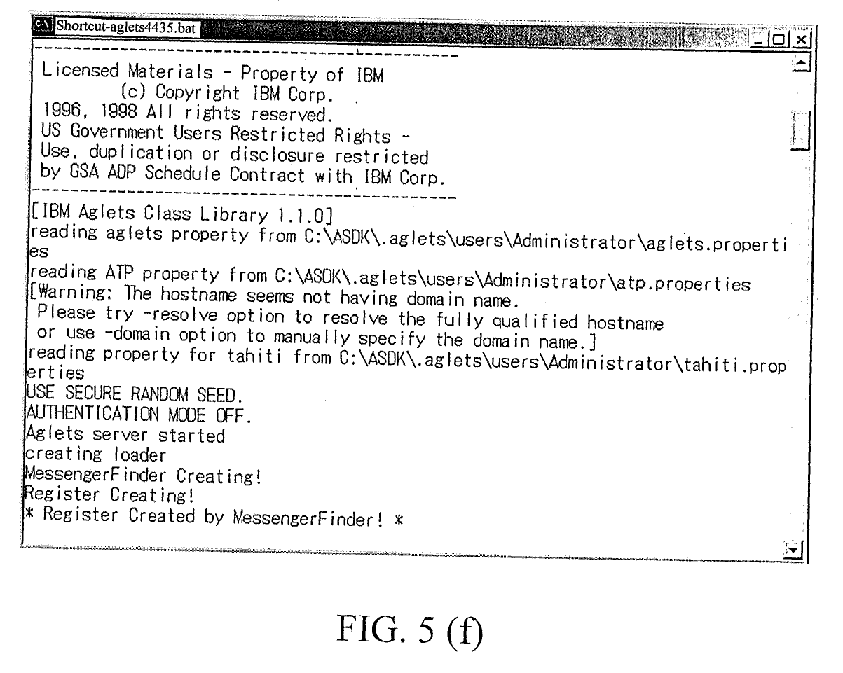

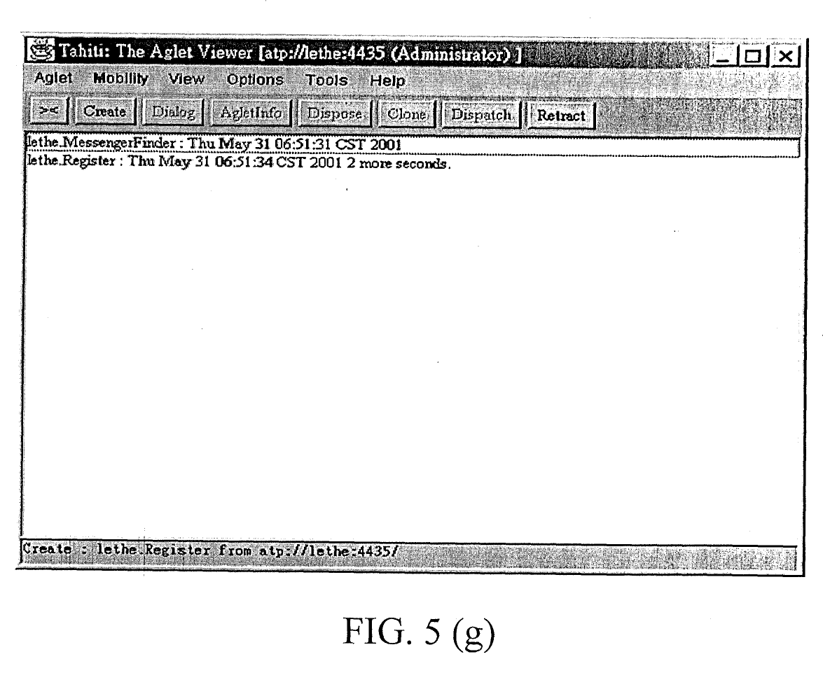

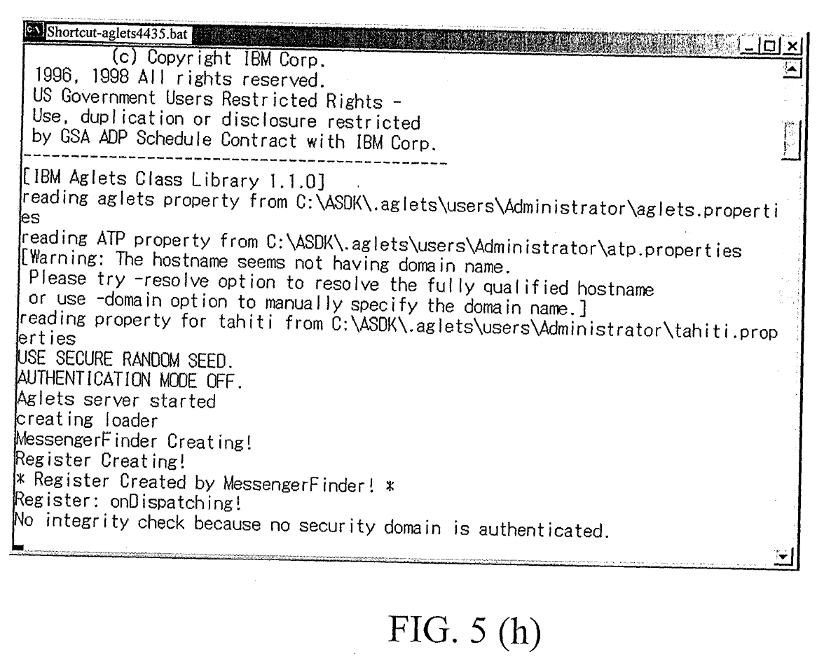

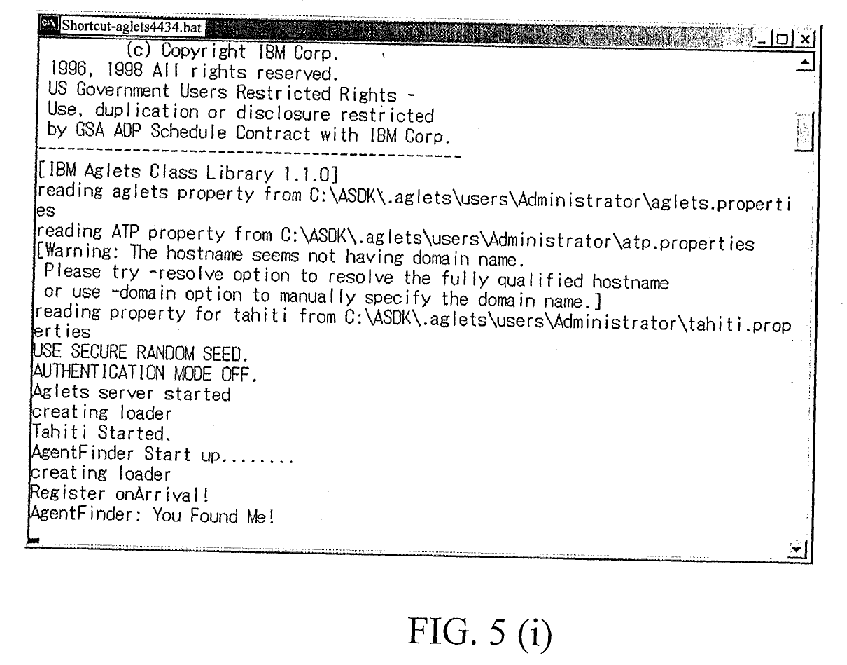

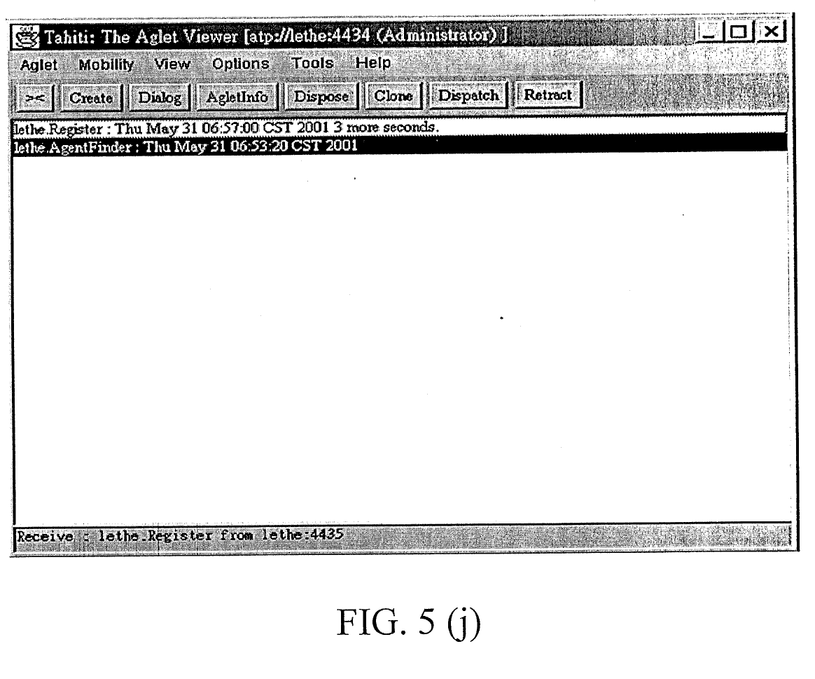

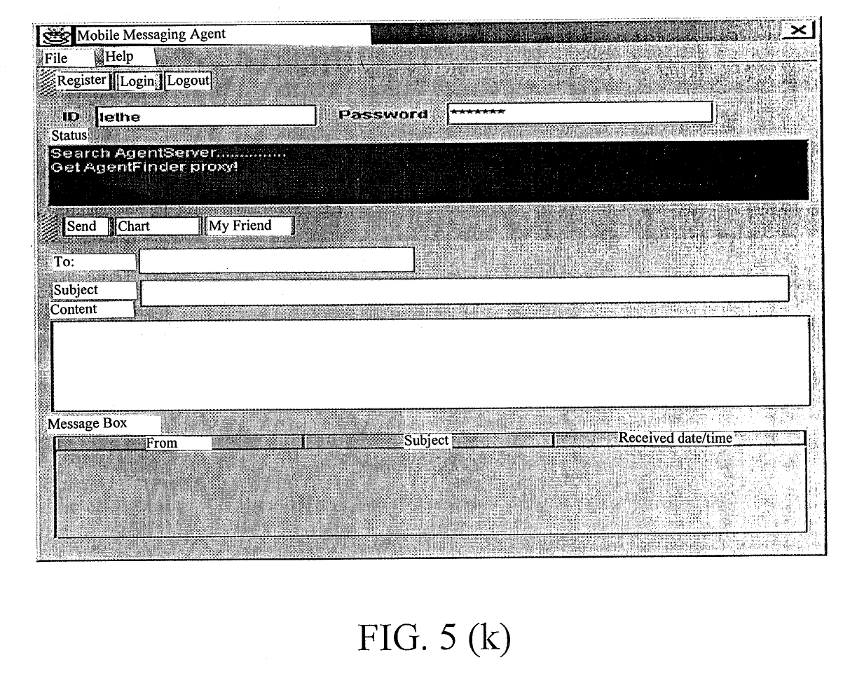

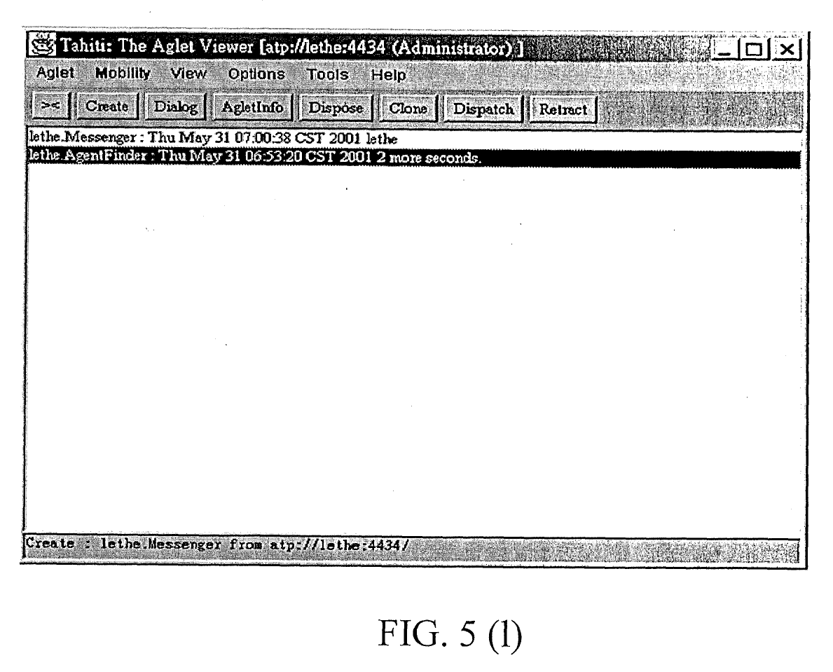

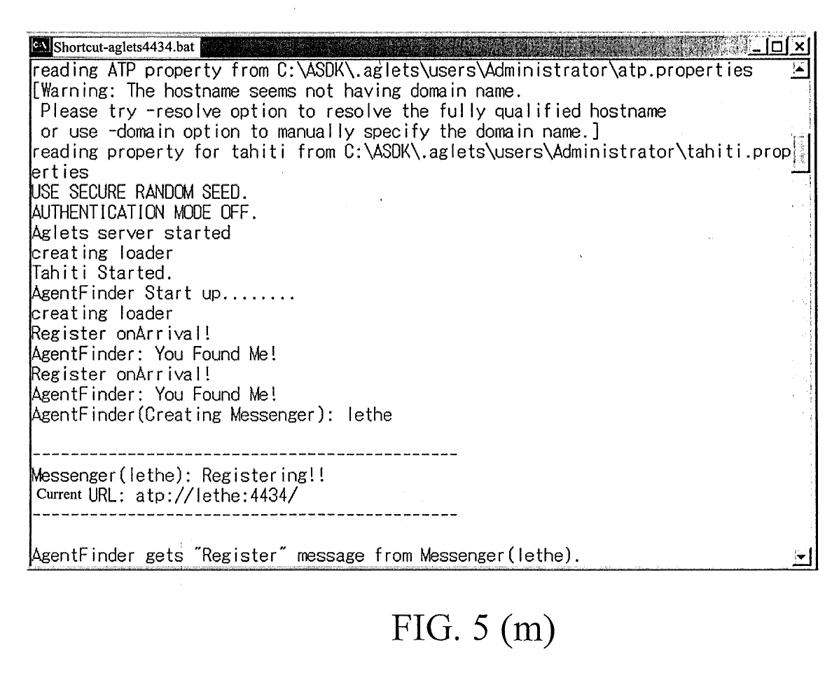

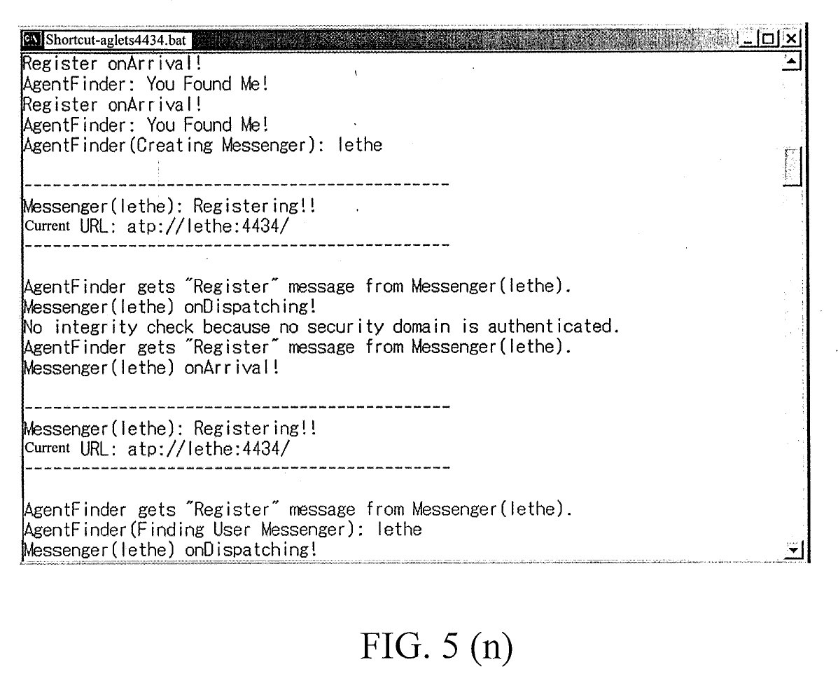

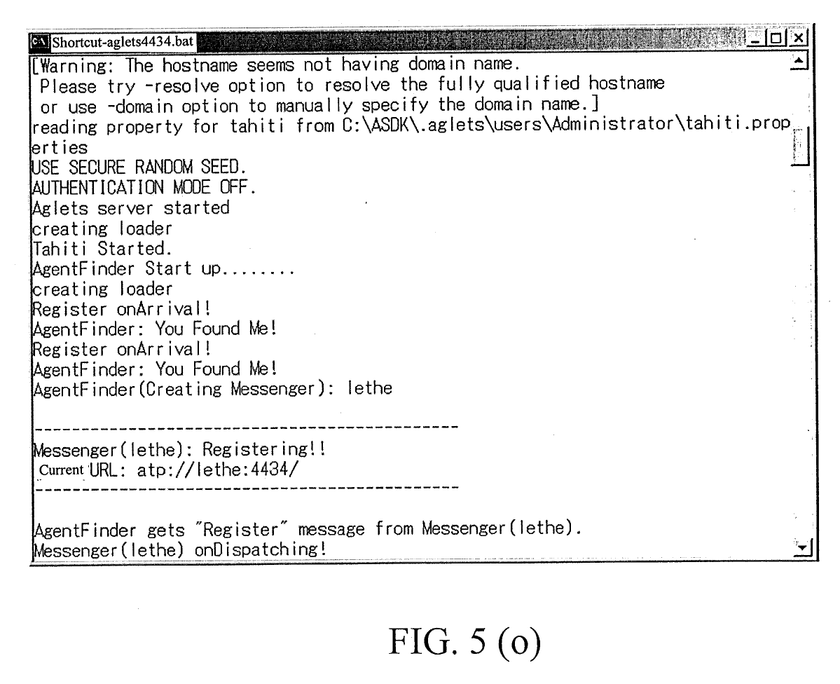

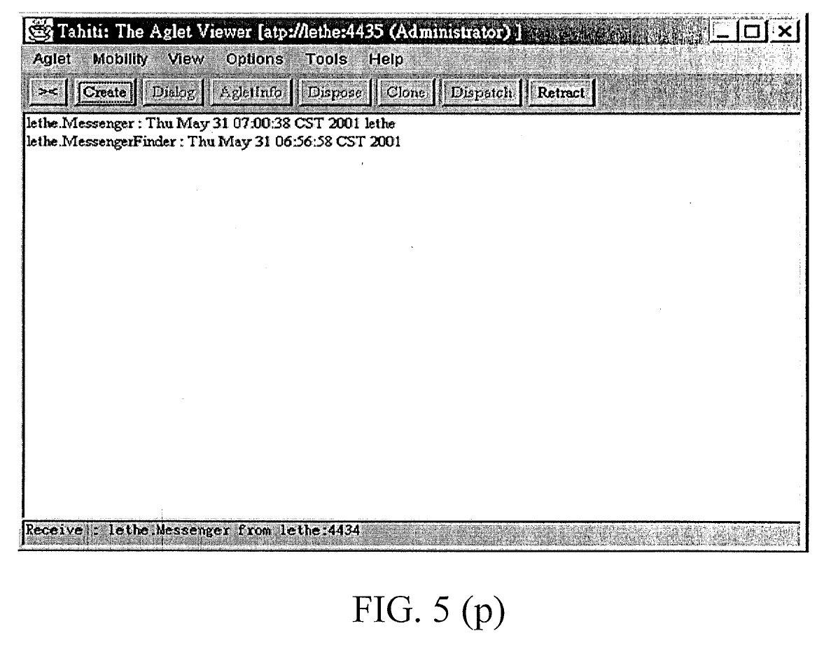

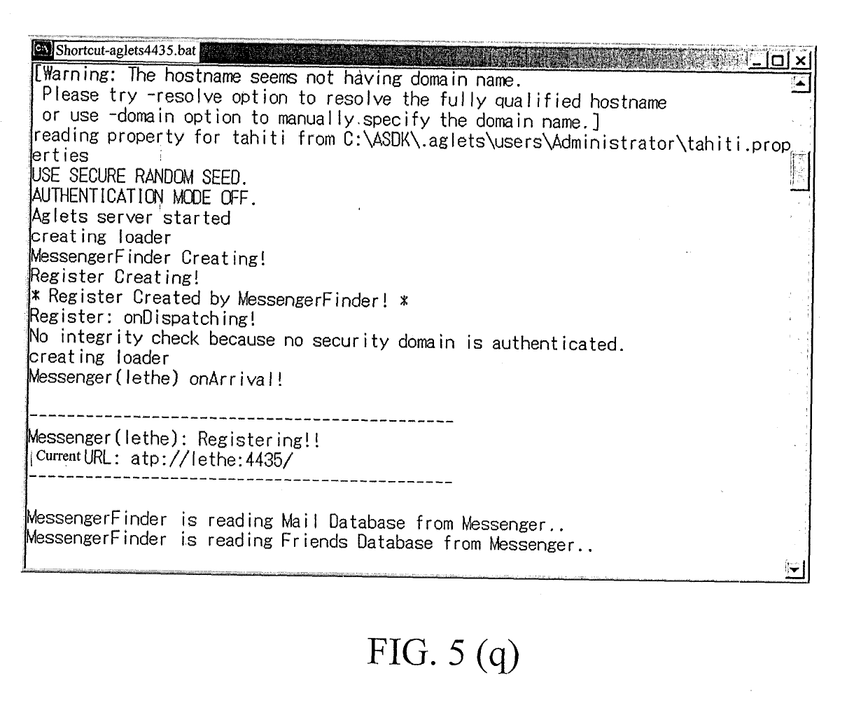

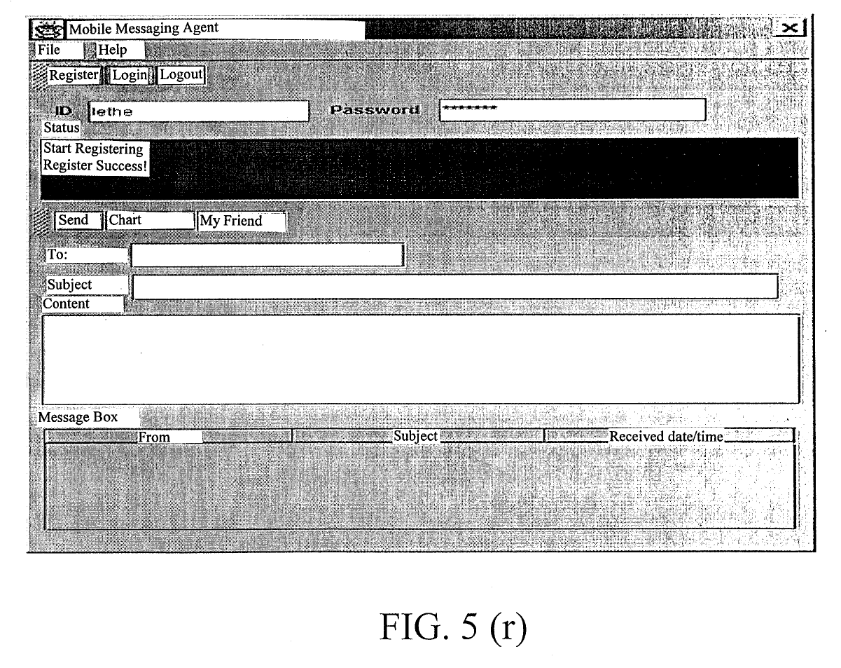

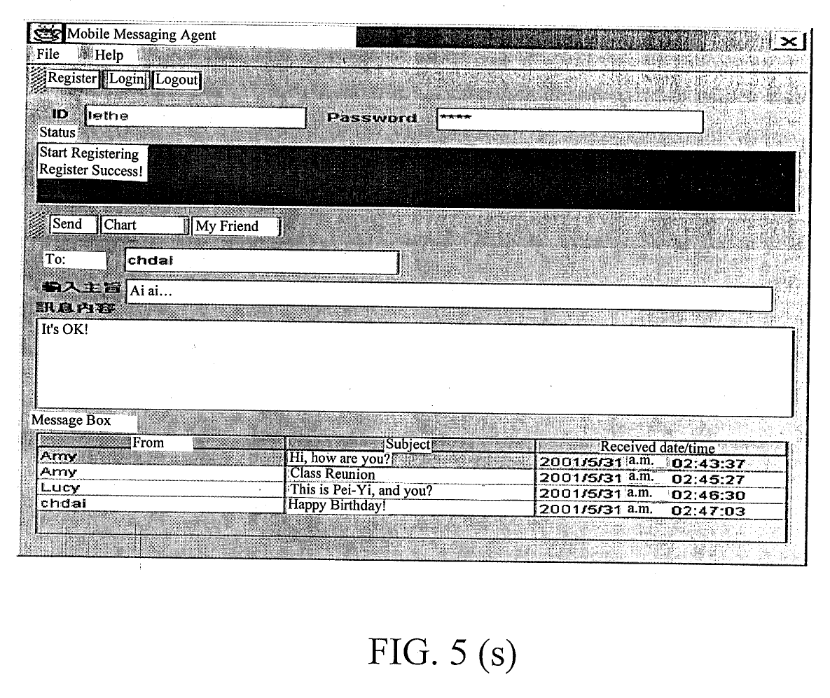

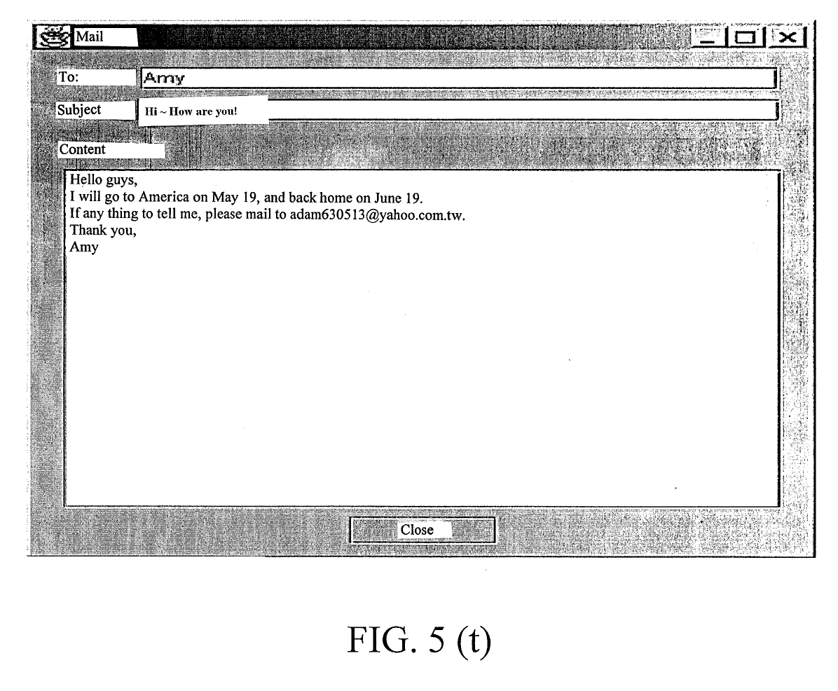

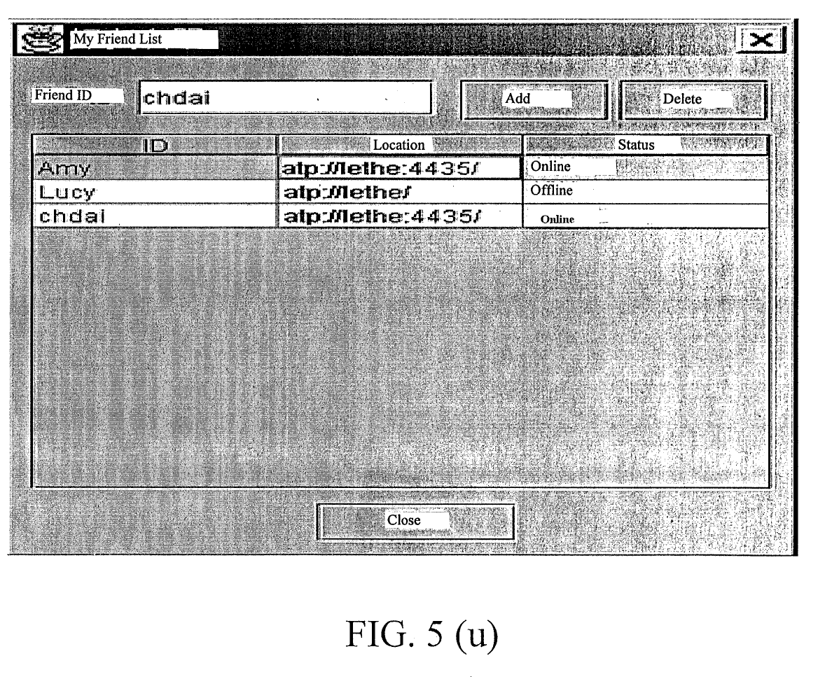

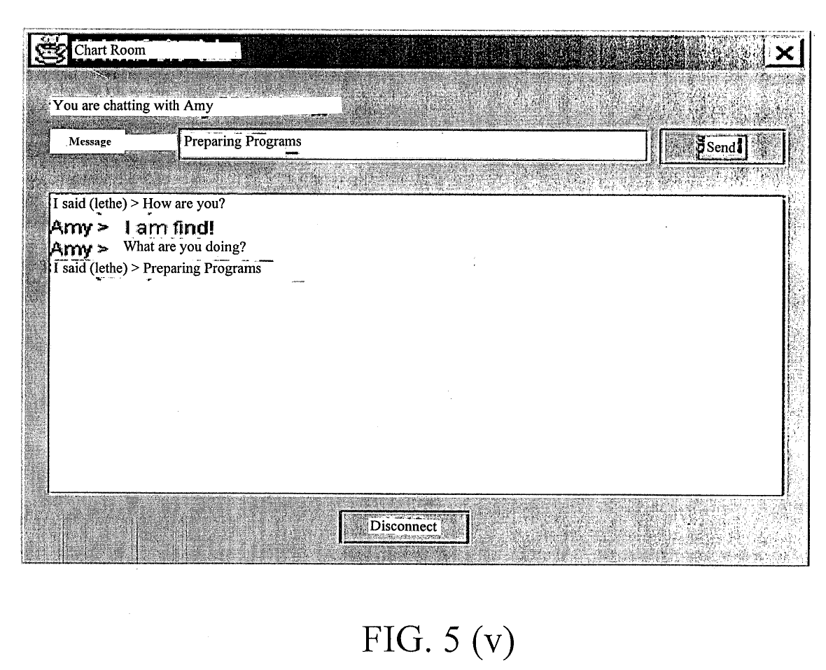

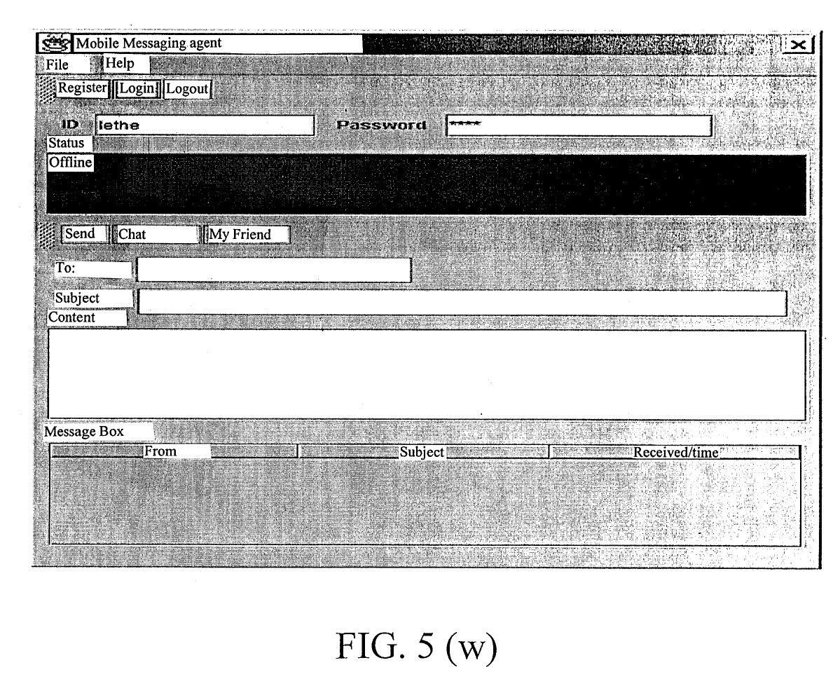

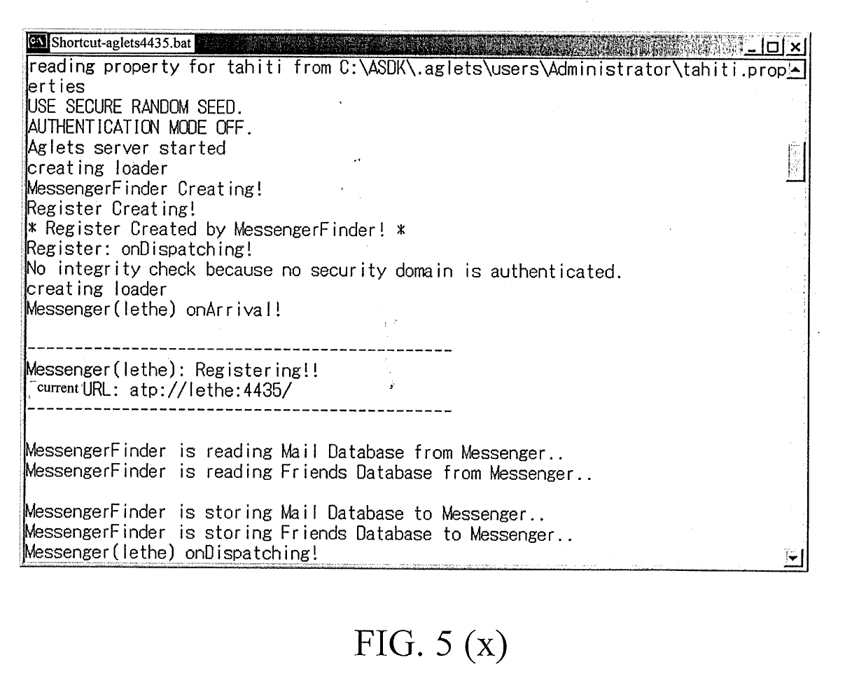

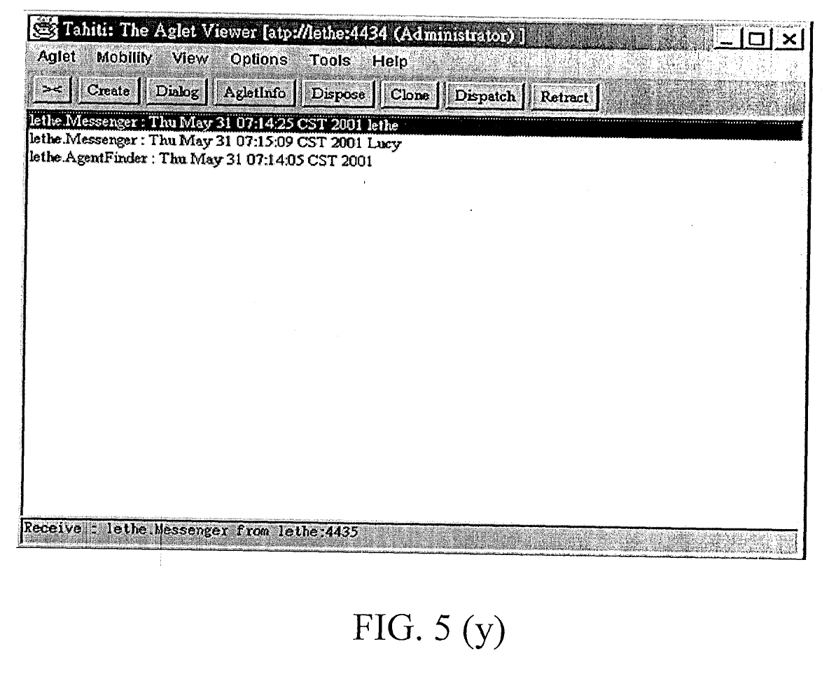

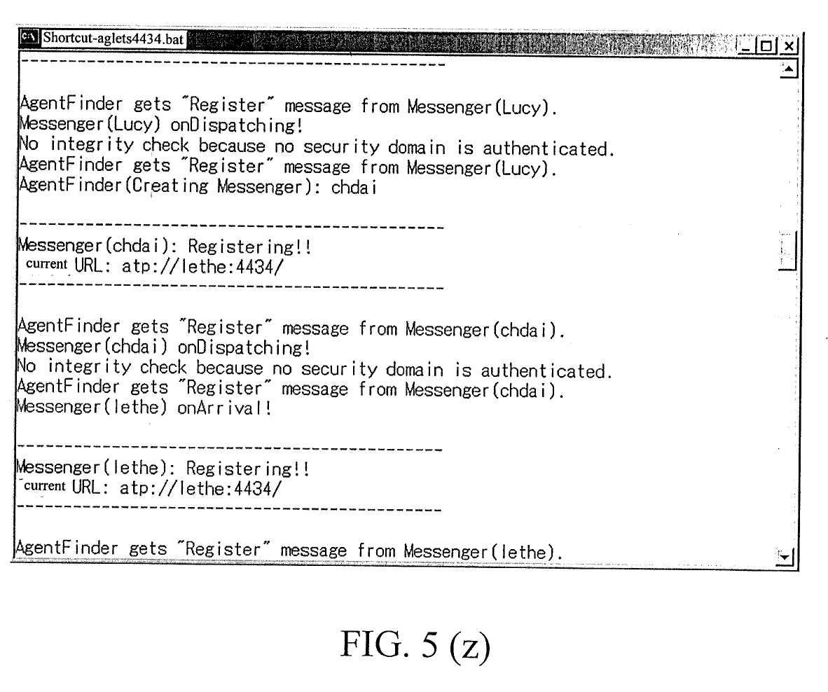

(1) Activating the server environment (step 21) (i.e., activating the Agent Finder 12): The Messenger 11 can be placed in, such as, the is Public path so as to be created by the Agent Finder 12. Two mobile agent programs, i.e., the Agent Finder 12 and the Messenger 11, are installed in the server 3. First of all, the user 1 activates the Agent Finder 12 on the host at, for example, URL “atp://lethe:4434/”, which is responsible for managing the messages of the Messenger 11, monitoring the locations of the Messenger 11, and receiving the commands of the user 1 from the clients 2 and 4 to the Messenger 11. FIG. 5(a) shows a display in a Windows Command mode when the user 1 activates the Agent Finder 12. FIG. 5(b) shows the Agent Finder 12 program running on a control management interface of the Aglets Tahiti (Tahiti management interface includes an AgletContext platform itself) for the mobile agent.

(2) Downloading agent programs of clients 2, 4 (step 22): The user 1 logs in the mobile messaging agent web site by means of the web browser or just uses a floppy disk to download the two agent programs, the Messenger Finder 13 and the Register 14. According to a preferred embodiment of the present invention, the mobile messaging agent system 10 is developed with the IBM Aglets™ API. This development tool is based on Java programming language, so that it is necessary to download the Sun JDK1.1 (Java™ Development Kit, JDK1.1.7B is recommended), or the JavaSoft JRE (Java™ Runtime Environment) software, which mainly comprises the Java Virtual Machine and the standard toolkit (Java™ classes.zip). The URL for downloading program for the mobile messaging agent system 10 of the present invention is http://www.lethe.idv.tw/Mobile Messaging Agent/. FIG. 5(c) shows the display of the test web site for the mobile messaging agent and the example of the downloaded program.

(3) User 1 activating the Messenger Finder (step 23): After downloading of the programs is complete, the user 1 executes the Messenger Finder 13. As shown in FIG. 5(d), the user 1 activates the Messenger Finder 13 on the host at URL “atp://lethe:4435/”, and the user interface for the Messenger Finder 13 designed with Java™ Swing is popped up automatically, as shown in FIG. 5(e).

(4) Locating the Agent Finder at the server 3 (step 24): After the user 1 has activated the Messenger Finder 13, the Messenger Finder 13 immediately pages the Register 14, as shown in FIG. 5(f). Then, the entity of the Register 14 appears on the AgletContext platform for the management interface Tahiti of the Agent Finder 12 (see FIG. 5(g)). After the Register 14 is generated, it then locates the Agent Finder 12 over the network. FIG. 5(h) shows the message “Register: onDispatching!” when the Register 14 is traveling. When the Register 14 arrives at the server 3 and finds the Agent Finder 12, it immediately sends to the Agent Finder 12 the message “ClientReg” sent from the Messenger Finder 13. After the Agent Finder 12 has received this message, the Windows Command display shows the prompt wording “AgentFinder: You Found Me!” (as shown in FIG. 5(i)). Then, as shown in FIG. 5(j), the title bar of the Tahiti AgletContext platform window shows the URL address “atp://lethe:4434” of the server 3. The dialog box also shows up the entity of the Register 14, which proves that the Register 14 has traveled from the AgletContext platform at the clients 2, 4 to the AgletContext platform at the server 3. Next, the Agent Finder 12 receives the Proxy for the Messenger Finder 13 for the user 1 that is notified by the Register 14. The Agent Finder 12 sends, through this Proxy, its own Proxy to the client Messenger 13 on the computer at the client 2. Then, the Register 14 has accomplished the intended task and then is disposed of automatically.

(5) The logging-in and account registration of User 1 (step 25): After the Messenger Finder 13 obtains the Proxy for the Agent Finder 12, the status bar in the Java Swing management interface of the Messenger Finder 13 will show a prompt wording “Get AgentFinder Proxy!” (as shown in FIG. 5(k)). Then, the user 1 can proceed with entering his account and password through the Java Swing management interface of the Messenger Finder 13 so as to register with or log in the mobile messaging agent system 10. Because the mobile messaging agent system 10 of the present invention is developed based on the Java programming language and the Java has the encapsulation capability of data, the entered password and messages are provided with highly secured protection mechanism.

(6) Logging in the system: When the user 1 uses the mobile messaging agent system 10 for the first time, he needs to proceed with the registration procedure (step 26). When the Agent Finder 12 at the server 3 receives the registration message from the clients 2, 4, the Agent Finder 12 will store the account and password registered by the user 1 in the agent database 15, and also create a Messenger 11 program (step 27), which is the Messenger associated with the user 1 (as shown in FIG. 5(l)). FIG. 5(m) illustrates a procedure that the user 1 registers for an account, and a Messenger 11 is created by the Agent Finder 12 and then registers with the Agent finder 12. According to the present invention, whenever the Messenger 11 is first created or travels to a new environment (i.e. AgletContext platform), the registration process will be conducted.

If the user 1 has already used the mobile messaging agent system 10, it is not necessary for him to register for a new account and create the Messenger 11. Thus, the user 1 can just send out a paging message to the originally dedicated Messenger 11 through the Agent Finder 12 (step 28). FIG. 5(n) shows a display when a Messenger 11 is being paged. No matter the Messenger 11 is paged or first created, it is immediately dispatched to the location of the user 1. FIG. 5(o) illustrates that an agent program of the Messenger 11 has already been created and is ready to be dispatched to the client.

(7) Messenger 11 traveling to clients 2 and 4 (step 29): FIG. 5(p) illustrates that the Messenger 11 physically enters the Tahiti AgletContext platform at the clients 2 and 4. When the Messenger 11 arrives at the clients 2 and 4, the agent program of the Messenger Finder 13 will read the data in the mailbox 16 of the Messenger 11 and the friend's list data, and store them in the local database (not shown) of the Messenger Finder 13 (as shown in FIG. 5(q)). FIG. 5(r) shows a display of successful registration as shown in the program window of the Messenger Finder 13 after the user 1 has successfully registered with the Agent finder 12.

(8) Messenger 11 being at Service when User 1 is on-lined (step 30): When the user 1 logs in or successfully registers, he can start to use the mobile messaging agent system 10, and operate the Messenger 11 through the window designed with the Java™ Swing to proceed with sending messages in the mobile agent mechanism. FIG. 5(s) to FIG. 5(v) show the displays of the cases when the Messenger 1 performs sending mails, opening mails, friend's list and chat room, respectively.

(9) User 1 being off-lined or the Messenger Finder being closed (step 31): The user 1 manipulates the off-lining procedure of the Messenger 11 by way of the main display for the agent program of the Messenger Finder 13 (as shown in FIG. 5(w)). In the off-lining procedure, the Messenger Finder 13 writes the mail data and the friend's list data into the mailbox 16 of the Messenger 11 and the friend's list. Such a data storage scheme is so operated that the user 1 conducts data management in the local database whenever on-lined, and then writes back the data into the agent program of the Messenger 11 at one time (Write-Back strategy). FIG. 5(x) illustrates that the agent program of the Messenger 11 is ready to return to the server after receiving the data stored in the local database by the Messenger Finder 13.

(10) Messenger returning to the server (step 32): After the Messenger 11 has returned to the server 3, it again registers with the Agent Finder 12 (as shown in FIG. 5(y)), and normally remains on the AgletContext platform at the server in a standby mode, waiting for the next paging from the user 1. The Messenger 11 automatically receives the messages associated with the user 1 while the user 1 is off-lined. FIG. 5(z) illustrates that the Messenger 11 remains on the Tahiti AgletContext platform at the server in a standby mode.

Advantageous Effectiveness of the present invention

The structural comparison of the mobile messaging agent system according to the present invention with conventional messaging mechanisms for e-mail, and ICQ personal paging is given as follows:

(1) The messages of the e-mail and ICQ personal paging are both required to be transmitted via the server, thereby inevitably resulting in a heavy load on the server and the network. Instead, the mobile messaging agent system 10 institutes the message transmission by paging the Messenger 11. According to the present invention, the paging loads on the server 3 are relatively reduced, and the Messenger 11 would not repetitively send out messages, which can also reduce the network loads.

(2) The messages of the e-mail and ICQ personal paging both have to be stored in the server first and then forwarded to the recipient such that the security of the information stored by another third party is significantly reduced. On the contrary, the mobile Messenger system 10 directly sends messages by means of the agent program to the Messenger for the recipient. The applicant's research results reveal that the user's data has a highly security and more privacy since it is not necessary to store in the server the messages sent by the mobile messaging agent system of the present invention.

(3) In the conventional e-mail scheme, mails are sent through complicated and tedious procedure to ensure that the mails can be reliably sent to the recipient. In contrast, the mobile messaging agent of the present invention sends messages through the Proxy for the agent. The applicant's research results reveals that as long as a message is sent to the Proxy for the recipient, the recipient can read the message.

(4) The breakdown of the e-mail server of an e-mail system will inevitably causes the mails to fail to be downloaded normally. In contrast, the mobile messaging agent has equipped itself with a mailbox. The research results of the present invention show that the mailbox 16 always travels by following the changing of the location of the user 1. That is, the mailbox always travels to the position where the user 1 moves to, thereby more efficiently managing the messages.

(5) It is difficult and complicated to configure an e-mail system. In the mobile messaging agent, the Messenger is in the name of the registered account by the user 1, and the Messenger also records with the configuration of the user 1. In operation, the user only needs to enter his/her account and password to log in the mobile messaging agent system, and then connects to his/her Messenger.

(6) The client software for each of the e-mail system and the ICQ personal paging needs to be configured with different kinds of platform software according to different operating systems. The client program for the mobile messaging agent of the present invention is developed with Java programming language, and this program communicates with the operating system via a virtual machine. In the present invention, the same client program can run under different operating systems, i.e., it can function well from one platform to another.

(7) The messages of the e-mail system and the ICQ personal paging based on the TCP/IP protocol are apt to be intercepted. According to the mobile messaging agent system 10 of the present invention, the Proxy security scheme is employed to encapsulate the messages to be transmitted, and the Java language is also provided with high data encapsulation. Thus, the present invention provides with a highly secured scheme for the message transmission, which prevents from damaged caused by any invader.

(8) The Messenger 11 is always in a standby mode, and the mobile messaging system can also operate in an asynchronous manner. When the user 1 is off-lined, the Messenger 11 continuously receives the messages associated with the user 1. Such a scheme can also be applied to monitor special alarm messages that the user 1 can review when on-lined. The mobile messaging agent of the present invention is provided with inherent heterogeneity and mobility such that it can be applied in the future mobile computing environment by only installing the environmental program without further developing any new transmission protocol and messaging architectures.

(9) According to the present invention, the mechanism for rolling back the mails sent is provided. When the recipient is off-lined, the mails to the recipient will be sent out and preserved by the Messenger associated with the sender (i.e. stored in the mailbox of the Messenger). In this case, the sender could regret sending mails and call back the mails at any time. Then, the Messenger will cancel the sending out mails in the mailbox. The traveling mailbox scheme of the present invention renders the Messenger automatically traveling to the computer at which the user is located, thereby facilitating the user to manage the associated mailbox asynchronously. In the present invention, the transmission of messages and mails is not conducted through the serving host, thereby avoiding the situations encountered in the conventional e-mail or ICQ program that the serving host is easily disengaged with or breaks down. On the contrary, in the conventional e-mail and ICQ messaging system, once mails or messages have been sent out, it is impossible to roll them back, because the they are delivered to the messaging queue on the mail host or messaging host (SMTP Server, ICQ Server) managed by the server.

As mentioned above, after the user 1 is off-lined, the Messenger 11 will automatically travel to the server 3. The messages and personal data of the user 1 are stored in the Messenger 11 of the shake of data privacy and security. According to another embodiment of the present invention, there is provided with another server to store those messages/mails and the user l's data in the Messenger 11 so as to avoid the situation that the server 3 is damaged by accident and thus the information of the Messenger 11 will lose. The agent program of the Messenger 11, a mobile computing program, cannot contain a large amount of data such that the extra messages and mails may be pre-stored in the computer at the position of the user 1.

### INDUSTRIAL APPLICABILITY

Given the above, it has been proved that the messaging mechanism of active messaging developed with the mobile agent technology is suitable for the applications over the network, for example, containing the financial goods, and alarm mechanism. In modem life, people can send out, by means of the mobile messaging agent mechanism of the present invention, messages, such as, the fluctuation of the stock price, the expiry date of checks, the expiry date of bills, etc. Another example is the house security, house guard, and house alarm. In the application for the mobile diagnosis of the hospital, the mobile messaging agent mechanism can be used to send to the doctor the signal from medical instruments, for example, in an intensive care unit, or to send the diagnosis data during doctors' mobile diagnosis at patients' homes, and the like. In the near future, such applications will be more and more popular with the development of mobile communication.

Mobile Messaging Agent Combined with a Personal Mobile Communication Apparatus

With the rapid development of the mobile equipment in the recent years, there comes the mobile computer era. Therefore, it is expected that the mobile messaging agent of the present invention will be equipped with personal mobile communication devices, such as mobile phone, personal digital assistant, lap-top computer and fax machine, etc., on the backend of the system to achieve the intended objects of the present invention of running among heterogeneous platforms and self-locating messages for the mobile messaging agent. Here, there is provided with a schematic diagram of the integration of the pre-process of the present invention with, for example, a mobile phone.

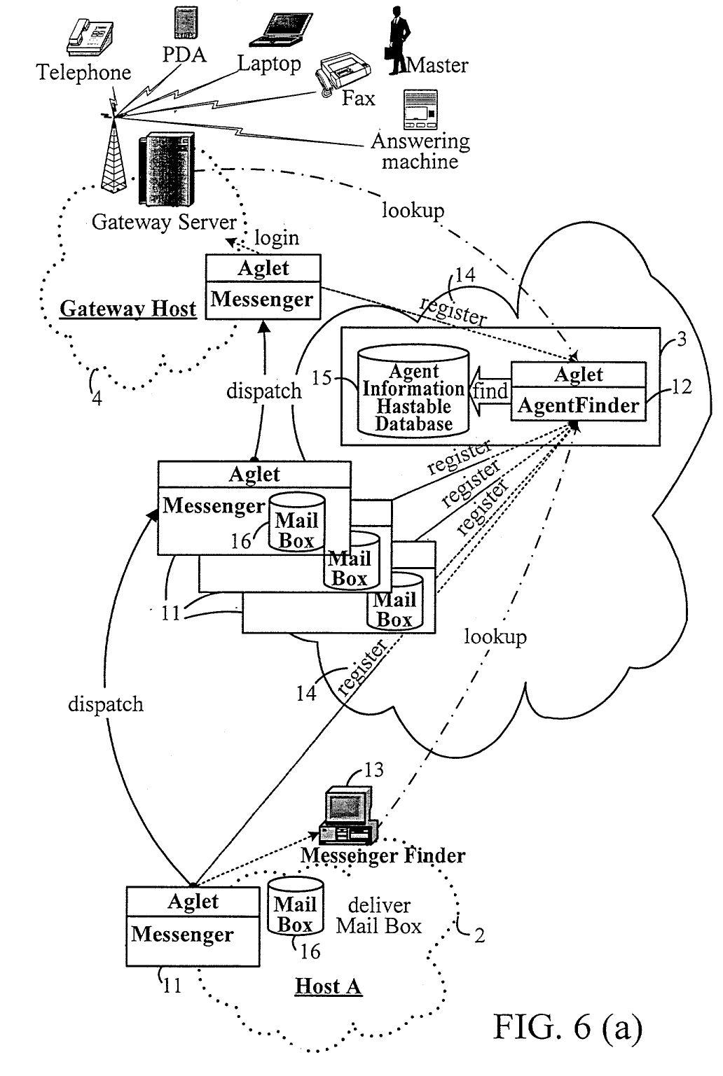

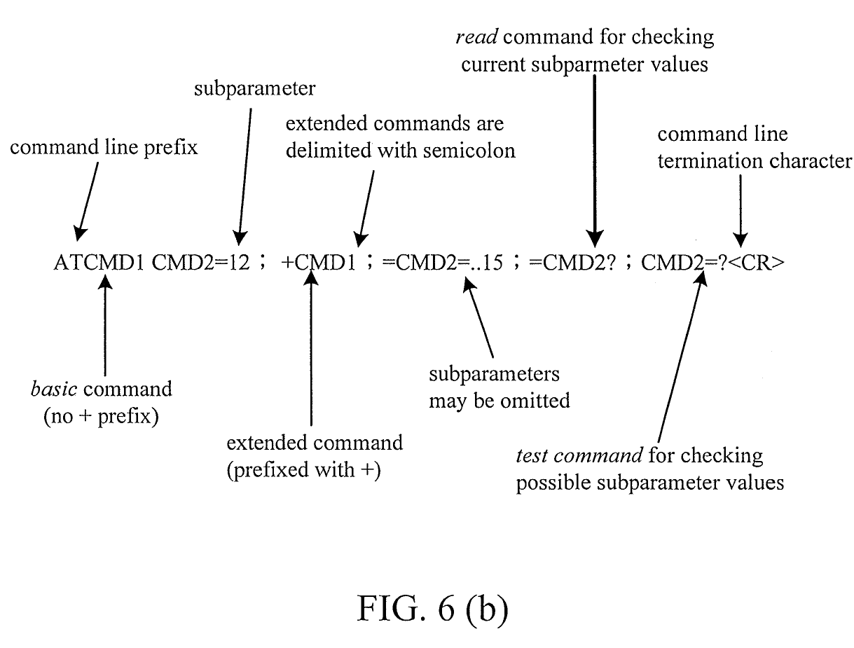

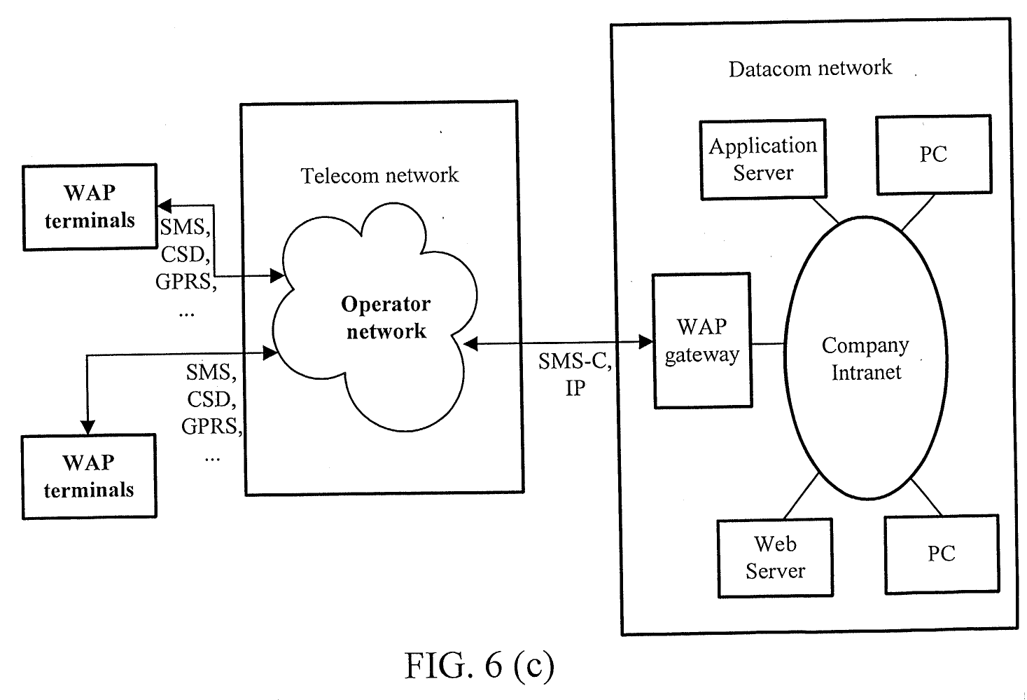

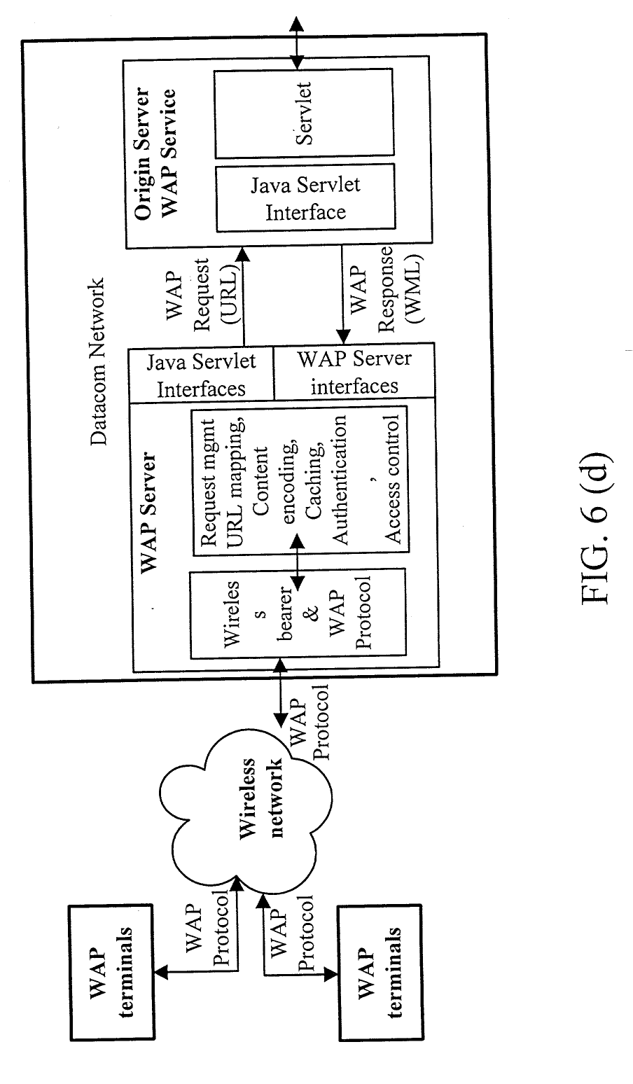

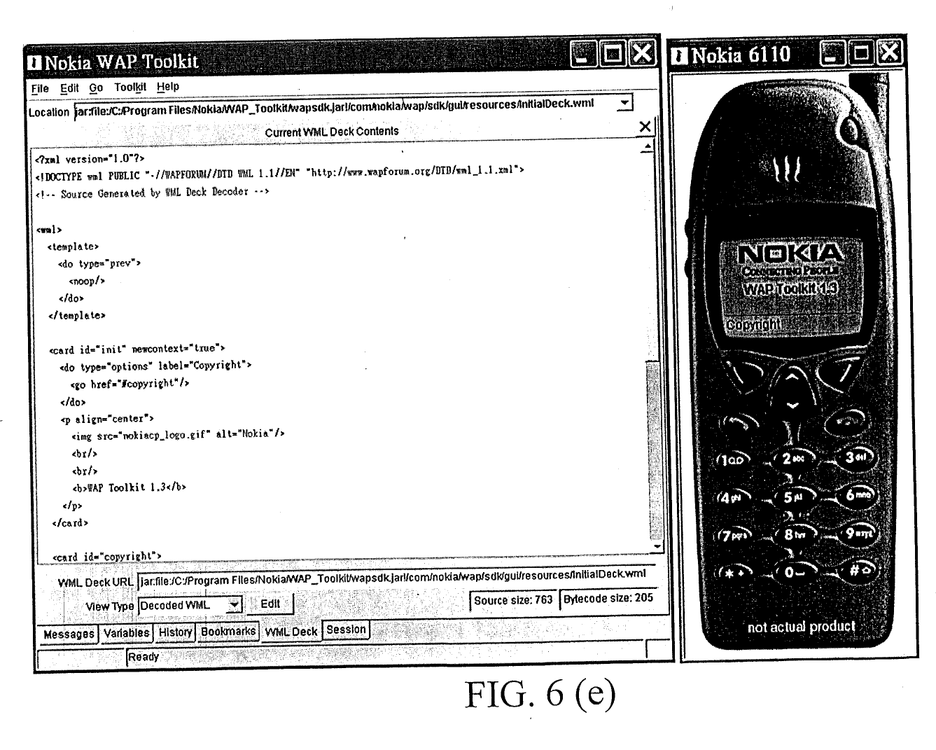

FIG. 6(a) illustrates an integration of the mobile messaging agent with the personal mobile messaging apparatus. Therefore, the present invention provides an example with an integrated mobile phone as the description for the pre-process of the integration.

1. First of all, the mobile phone sends a signal to the backend server (at the Gateway Server), and then the Messenger Finder on the backend server is activated to receive the message from the Messenger 11.

2. When the Messenger 11 arrives at the backend, the Messenger Finder then sends the message contained in the Messenger 11 to the mobile phone currently held by the message owner. The transmission between the Messenger Finder and the mobile phone can be done by the following two schemes:

(1) Sending a short message to the mobile phone: Giving commands at the AT-Command Line (as shown in FIG. 6(b)), in the backend computer connected, for example, via the RS-232 port, to the mobile phone to send the short message through the mobile phone to the master's (user's) mobile phone.

(2) Using WAP Gateway Server: If the mobile phone of the user 1 has the WAP function, this scheme can be employed. The mobile phone is operable to connect with the telecommunication network, and the data transmitted between the telecommunication network and the computer network can be converted by the WAP gateway. FIG. 6(c) illustrates a schematic diagram of a WAP Gateway Server connecting the computer network and the telecommunication network. Message is sent by the Java Servlet program on the WAP gateway to the mobile phone held by the master of the agent, who makes a request to the WAP gateway. FIG. 6(d) illustrates a schematic diagram of the Java Servlet on the WAP gateway, for example, a Nokia WAP gateway.

FIG. 6(e) shows the development interface in which the frontend of the mobile phone is simulated using Nokia Toolkit software, and the backend Gateway Server expresses the message from the Messenger Finder in WML (Wireless Markup Language) language and sends it to the WAP mobile phone through the Java Servlet.

The aforementioned embodiments and descriptions of the present invention are only illustrative but not restrictive. Those skilled in the art can make various modifications or changes without departing from the appended claims in the present invention. Each of the features of the present invention is described in the claims.

### REFERENCES

[1] Danny B. Lange and Mitsuru Oshima, “Mobile Agents with Java: The Aglet API,” World Wide Web, 1(3), September 1998.

[2] Danny B. Lange and Mitsuru Oshima, “Programming and Deploying Java™ Mobile Agents with Aglets™,” Addison-Wesley, 1998.

[3] David Chess, Colin Harrison, Aaron Kershenbaum, “Mobile Agents: Are They a Good Idea?,” T. J. Watson Research Center Yorktown Heights, New York, 1994.

[4] Dejan S. Milojicic, William LaForge, and Deepika Chauhan, “Mobile Objects and Agents(MOA).” The Open Group Research Institute, 1998.

1. A mobile messaging agent system for dynamically receiving and sending messages associated with an user from/to a computer at the current location of the user through the network, wherein the computer is connectable to a server through the network, the mobile messaging agent system comprising:
(a) a Messenger means, dynamically traveling over the network, for receiving and sending the messages associated with the user;
(b) a server agent means, located on the server, comprising:
(b1) an Agent Finder for monitoring the latest location and status for the Messenger means over the network, and managing the commands to the Messenger means from the user; and
(c) client agent means located on the computer at the current location of the user, comprising:
(c1) a Messenger Finder, which is activated by the user, for locating the Agent Finder through the network to find the Messenger means belonging to the user.

2. A mobile messaging agent system according to claim 1, wherein the server agent means further comprises:
(b2) an Agent Information Database for storing the Proxy at the location for the Messenger traveling over the network, wherein the Agent Finder reports the Proxy for the Messenger means for the user to the user from the database.

3. A mobile messaging agent system according to claim 1, wherein the client agent means further comprises:
(c2) a register, which is activated by the Messenger Finder, for locating the Agent Finder through the network, and sending the Proxy for the Agent Finder to the Messenger Finder.

4. A mobile messaging agent system according to claim 1, wherein when the user logs on the mobile messaging agent system for the first time, the Agent Finder creates the Messenger means in response to the message for generating the Messenger from the Messenger Finder to the Agent Finder.

5. A mobile messaging agent system according to claim 3, wherein when the user activates the Messenger Finder, the Messenger means travels to the computer.

6. A mobile messaging agent system according to claim 5, wherein when the Messenger means travels to the computer, it sends out the register to the Agent Finder so as to indicate the Proxy at the current location of the Messenger means, and the Proxy is stored in the Agent Information Database for tracking of the location of the Messenger.

7. A mobile messaging agent system according to claim 3, wherein, in response to the activation of the Messenger Finder by the user, the Messenger Finder will send out a lookup message to the Agent Finder through the Proxy for the Agent Finder, so as to locate the Messenger means for the user, and, in response to the lookup message, the Agent Finder locates the Proxy for the Messenger from the Agent Information Database, and returns the Proxy to the Messenger means finder, wherein the Messenger means finder pages the Messenger means through the Proxy.

8. A mobile messaging agent system according to claim 7, wherein the Agent Finder returns the Proxy to the Messenger Finder through the register.

9. A mobile messaging agent system according to claim 1, wherein the messages associated with the user comprise mails, account security alarm, stock market information or goods sales information.

10. A mobile messaging agent system according to claim 1, wherein the Messenger means comprises a mailbox means for storing mails or messages associated with the user.

11. A client agent means for dynamically receiving and sending messages associated with an user through the network, wherein the client agent means is connectable to a server through the network, the client agent means comprising:
a Messenger means, which is dynamically traveling over the network, for receiving and sending messages associated with the user; and
a Messenger Finder, which is activated by the user, for locating the Agent Finder in the server through the network to locate the Messenger means for the user, wherein the Agent Finder monitors the latest location and status of the Messenger means on the network, and manages the commands to the Messenger means from the user.

12. A client agent means according to claim 11, wherein the server further comprises an Agent Information Database for storing the Proxy at the location of the Messenger traveling on the network, wherein the Agent Finder reports the Proxy for the Messenger means for the user to the user from the database.

13. A client agent means according to claim 11, further comprising a register, which is activated by the Messenger Finder, for locating the Agent Finder through the network, and sending the Proxy for the Agent Finder to the Messenger Finder.

14. A client agent means according to claim 11, wherein when the user logs on the mobile messaging agent system for the first time, the Agent Finder creates the Messenger means, in response to the message for generating the Messenger means from the Messenger Finder to the Agent Finder.

15. A client agent means according to claim 13, wherein when the user activates the Messenger Finder, the Messenger means travels to the client agent means.

16. A client agent means according to claim 15, wherein when the Messenger means travels to the client agent means, it send out the register to the Agent Finder so as to indicate the Proxy at the current location of the Messenger means, and the Proxy is stored in the Agent Information Database for tracking of the location of the Messenger means.

17. A client agent means according to claim 13, wherein, in response to the activation of the Messenger Finder by the user, the Messenger Finder sends out a lookup message to the Agent Finder through the Proxy for the Agent Finder, so as to locate the Messenger means for the user, and, in response to the lookup message, the Agent Finder locates the Proxy for the Messenger from the Agent Information Database, and return the Proxy to the Messenger means finder, wherein the Messenger means finder pages the Messenger means through the Proxy.

18. A client agent means according to claim 13, wherein the Agent Finder returns the Proxy to the Messenger Finder through the register.

19. A client agent means according to claim 11, wherein the messages associated with the user comprises mails, account security alarm, stock market information or goods sales information.

20. A client agent means according to claim 11, wherein the Messenger means comprises a mailbox means for storing mails or messages associated with the user.

21. A server agent means for dynamically sending messages associated with an user to a client agent means through the network, wherein the client agent means comprises a client agent program, the server agent means comprising:
a Messenger means, which is dynamically traveling over the network, for receiving and sending messages associated with the user; and
an Agent Finder for locating and monitoring the latest location and status for the Messenger means over the network, and for managing the commands to the Messenger means from the user.

22. A server agent means according to claim 21, further comprising an Agent Information Database for storing the Proxy at the location of the Messenger traveling over the network, wherein the Agent Finder reports the Proxy for the Messenger means for the user to the user from the database.

23. A server agent means according to claim 21, further comprising a register, which is activated by the Messenger Finder, for locating the Agent Finder through the network, and sending the Proxy for the Agent Finder to the Messenger Finder.

24. A server agent means according to claim 21, the Agent Finder creates the Messenger means in response to the message for generating the Messenger from the Messenger Finder to the Agent Finder.

25. A server agent means according to claim 23, wherein when the user activates the Messenger Finder, the Messenger means travels to the client agent means.

26. A server agent means according to claim 25, wherein when the Messenger means travels to the client agent means, it sends out the register to the Agent Finder so as to indicate the Proxy at the current location of the Messenger means, and the Proxy is stored in the Agent Information Database for tracking of the location of the Messenger.

27. A server agent means according to claim 23, wherein, in response to the activation of the Messenger Finder by the user, the Messenger Finder sends out a lookup message to the Agent Finder through the Proxy for the Agent Finder, so as to locate the Messenger means for the user, and, in response to the lookup message, the Agent Finder locates the Proxy for the Messenger from the Agent Information Database, and returns the Proxy to the Messenger means finder, wherein the Messenger means finder pages the Messenger means through the Proxy.

28. A mobile messaging agent system according to claim 27, wherein the Agent Finder returns the Proxy to the Messenger Finder through the register.

29. A mobile messaging agent system according to claim 21, wherein the messages associated with the user comprise mails, account security alarm, stock market information or goods sales information.

30. A method of dynamically receiving and sending messages associated with a user from/to the computer at the location of the user, the computer is connectable to a server through the network, the method comprising the steps of:
(a) providing a Messenger means, which dynamically travels over the network, for receiving and sending the messages associated with the user;
(b) providing the server with an Agent Finder for locating and monitoring the latest location and status of the Messenger means over the network, and managing the commands to the Messenger means from the user;
(c) providing the computer with a Messenger Finder, which is activated by the user, for locating the Agent Finder through the network to locate Messenger means for the user;
(d) paging, by means of a Messenger Finder, a register to locate the Agent Finder through the network;
(e) locating the Agent Finder, by means of the register, and requesting the Agent Finder to use a controller for the Agent Finder, and sending, by means of the register, the controller for the Agent Finder to the Messenger Finder;
(f) executing the Messenger Finder to notify, via the controller for the Agent Finder, the Agent Finder of locating the Messenger means;
(g) sending, by means of the Agent Finder, the controller of the Messenger means to the Messenger Finder for locating the Messenger means through the Proxy for the Messenger means; and
(h) requesting the Messenger traveling to the Messenger Finder, by means of the controller of the Messenger within the Messenger Finder, and sending the messages associated with the user to the Messenger Finder.

31. A method according to claim 30, when the Messenger means travels to the Messenger Finder, the method further comprises the step of:
(i) providing, by means of the register, a controller for the location of the computer to the Agent Finder.

32. A method according to claim 30, further comprising the step of equipping the controller with a Proxy.

33. A mobile messaging agent system according to claim 2, wherein when the Messenger sends out, by means of the Proxy for the Agent Finder, a message for rolling back mails, notifying the Agent Finder to modify the data in the Agent Information Database by deleting the data indicating that mails or messages from the user are to be sent to a recipient.

34. A mobile messaging agent system according to claim 33, wherein the Messenger means comprises a mailbox means for storing mails or messages associated with the user, and the Messenger means returns the mails or messages stored in the mailbox means to the user for modification or deletion.

35. A recording medium, recorded with computer programs, which when executed by a computer to perform the method for dynamically receiving and sending messages associated with a user from/to a computer at the location of the user, the computer is connectable to a server through the network, the method comprising the steps of:
(a) providing a Messenger means, dynamically traveling over the network, for receiving and sending the messages associated with the user;
(b) providing the server with an Agent Finder for locating and monitoring the latest location and status of the Messenger means over the network, and managing the commands to the Messenger means from the user;
(c) providing the computer with a Messenger Finder, which is activated by the user, for locating the Agent Finder through the network to locate the Messenger means for the user;
(d) paging, by means of the Messenger Finder, a register to locate the Agent Finder through the network;
(e) locating the Agent Finder by means of the register and requesting for the utilization of a controller for the Agent Finder, wherein the register sends the controller to the Messenger Finder;
(f) executing the Messenger Finder to notify, via the controller of the Agent Finder, the Agent Finder of locating the Messenger means;
(g) sending the controller of the Messenger, by means of the Agent Finder, to the Messenger Finder, which can then locate the Messenger through the Proxy for the Messenger; and
(h) using the Messenger Finder to request the Messenger traveling to the Messenger Finder through the controller of the Messenger, and sending the messages associated with the user to the Messenger Finder.

36. A recording medium according to claim 35, when the Messenger travels to the Messenger Finder, the method further comprises the step of:
(i) providing, by means of the register, the controller for the location of the computer to the Agent Finder.

37. A recording medium according to claim 35, wherein the controller is a Proxy.
